(19) United States
(12) Patent Application Publication
(10) Pub. No.: US 2016/0278375 A1
(43) Pub. Date: Sep. 29, 2016

(54) BISCATIONIC AND TRISCATIONIC AMPHIPHILES AS ANTIMICROBIAL AGENTS

(71) Applicants: Temple University of the Commonwealth System of Higher Education, Philadelphia, PA (US); Villanova University, Philadelphia, PA (US)

(72) Inventors: William WUEST, Wallingford, PA (US); Kevin Patrick MINBIOLE, Media, PA (US)

(73) Assignees: TEMPLE UNIVERSITY OF THE COMMONWEALTH SYSTEM OF HIGHER EDUCATION, Philadelphia, PA (US); VILLANOVA UNIVERSITY, Philadelphia, PA (US)

(21) Appl. No.: 15/034,404

(22) PCT Filed: Nov. 5, 2014
(86) PCT No.: PCT/US2014/064114

§ 371 Date: May 4, 2016

Related U.S. Application Data
(60) Provisional application No. 61/900,037, filed on Nov. 5, 2013.

(51) Int. Cl. A01N 33/12

(52) U.S. Cl. CPC A01N 33/12

(57) ABSTRACT

The present disclosure provides an antimicrobial composition including a compound which is a biscationic or triscationic amphiphile, and the method of making such an antimicrobial composition, and the method of using such a compound or composition for antimicrobial use. The antimicrobial composition can include a compound having the formula (I) wherein R is a methylene group unsubstituted or optionally substituted, s is an integer in the range from 1 to 6, R₁, R₂, R₃ or R₄ is H or a C₁₋₄ alkyl unsubstituted or optionally substituted, X is a halogen, m and n are integers in the range from 5 to 25, and m is not equal to n. Alternatively, the antimicrobial composition can comprise a compound having the formula (III) or (IV) wherein R₁, R₂, R₃, R₄ R₅, or R₆ is H or a C₁₋₄ alkyl unsubstituted or optionally substituted, X or Y is a halogen, and m and n are integers in the range from 5 to 25.

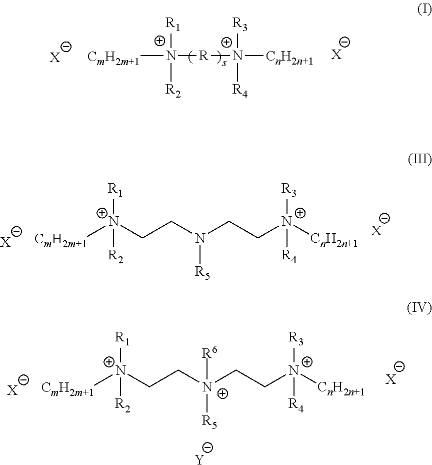

### PRIORITY CLAIM AND CROSS-REFERENCE

This application claims the benefit of U.S. Provisional Application No. 61/900,037, filed Nov. 5, 2013, which application is expressly incorporated by reference herein in its entirety.

### FIELD

The disclosure relates to antimicrobial compositions and related methods. More particularly, the disclosed subject matter relates to a composition comprising a biscationic or triscationic amphiphile, and the method of using such an amphiphile for antimicrobial use.

### BACKGROUND

The preparation of chemical agents to counter the spread of human pathogens has been a challenge long before the term medicinal chemistry was coined. From the fermentation of beverages to the preparation of bleach, the facile production of compounds to minimize the pathogenic effects of microbes has been a key concern. Development of bacterial resistance to even the most potent antibiotics has ensured that continued research into antimicrobial compounds will remain crucial.

### SUMMARY OF THE INVENTION

This Summary is provided to present a summary of the invention to briefly indicate the nature and substance of the invention. It is submitted with the understanding that it will not be used to interpret or limit the scope or meaning of the claims.

The present disclosure provides an antimicrobial composition comprising a compound which is a biscationic or triscationic amphiphile, and the method of making such an antimicrobial composition, and the method of using such a compound or composition for antimicrobial use. The compound or the composition provided in the disclosure has an ability to kill or inhibit the growth of microorganisms, including but are not limited to bacteria, viruses, yeast, fungi, and protozoa, to attenuate the severity of a microbial infection, or to kill, eradicate or disperse pre-established bacterial biofilms (i.e. antibiofilm use).

In some embodiments, the present disclosure provides a method of killing or inhibiting microbial growth, comprising applying an antimicrobial composition comprising a compound having the formula

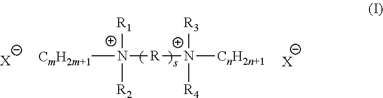

wherein:

R is a methylene group unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

s is an integer in the range from 1 to 6,

R₁, R₂, R₃ or R₄ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

R′ is H or a C₁₋₄ alkyl,

X is a halogen (in the form of anion),

m and n are integers in the range from 5 to 25, and

m is not equal to n.

For example, in some embodiments, R is a methylene group, and s is an integer in the range from 2 to 5. R₁, R₂, R₃ or R₄ is a C₁₋₄ alkyl, and X is fluorine, chlorine, bromine or iodine, tosylate, citrate, any suitable anions or combinations thereof.

In some embodiments, the antimicrobial composition comprises a compound having the formula

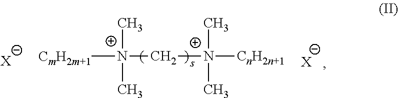

denoted as compound (m, s, n) halide, wherein s is an integer in the range from 1 to 6, X is a halogen in the form of anion, m and n are integers in the range from 5 to 25, and m is not equal to n. For example, s is an integer in the range from 2 to 5, and X is chlorine or bromine (in the form of chloride or bromide ion) in some embodiments. The compound having the formula (II) is a bi(quaternary ammonia) halide having an asymmetric structure.

In some embodiments, m+n is in the range of from 18 to 36, and the difference between m and n is in the range from 1 to 10. The compound having the formula (II) denoted as a compound (m, s, n) halide can be a bromide and can be selected from a group consisting of: compound (20, 2, 16), compound (20, 2, 14), compound (20, 2, 14), compound (20, 2, 10), compound (20, 2, 8), compound (20, 2, 6), compound (18, 2, 16), compound (18, 2, 14), compound (18, 2, 12), compound (18, 2, 10), compound (16, 2, 8), compound (14, 2, 12), compound (14, 2, 10), compound (14, 2, 8), compound (12, 2, 10), compound (12, 2, 8), compound (13, 2, 10), compound (13, 2, 10) and compound (10, 2, 8).

In some embodiments, m+n is in the range of from 20 to 24. The difference between m and n is in the range from 1 to 8. The compound having the formula (II) denoted as compound (m, s, n) halide can be a bromide and can be selected from a group consisting of: compound (16, 2, 8), compound (14, 2, 10), compound (14, 2, 8), compound (12, 2, 10), compound (12, 2, 8), compound (13, 2, 10) and compound (11, 2, 10).

In some embodiments, the present disclosure provides an antimicrobial composition comprising a compound having the formula (I) as described, and a carrier such as a solvent. The antimicrobial composition can also comprise other ingredients and additives. In some embodiments, the compound having the formula (I) in such an antimicrobial composition is a compound having the formula (II) denoted as compound (m, s, n) halide as described.

The present disclosure also provides a method of making an antimicrobial composition comprising mixing a compound having the formula (I) and a carrier such as a solvent. In some embodiments, such a method comprising mixing a carrier or other ingredients and a compound having the formula (II) denoted as compound (m, s, n) halide as described.

In another aspect, the present disclosure provides an antimicrobial composition, comprising an effective amount of a compound having the formula:

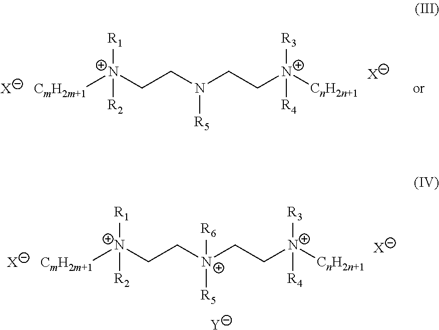

wherein:

R₁, R₂, R₃, R₄ R₅, or R₆ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

R′ is H or a C₁₋₄ alkyl,

X or Y is a halogen (in the form of anion), and

m and n are integers in the range from 5 to 25.

In some embodiments, R₁, R₂, R₃, R₄ R₅, or R₆ is H or a C₁₋₄ alkyl unsubstituted (e.g., methyl). X or Y is fluorine, chlorine, bromine, iodine, tosylate, citrate, any suitable anions or combinations thereof m can be equal to n, or m is not equal to n. m and n can be integers in the range from 10 to 14 in some embodiments.

In some embodiments, R₁, R₂, R₃, R₄ R₅, or R₆ is methyl, X is bromine, Y is iodine and the compound having formula (III) or (IV) is denoted as compound (m, 2, 0, 2, n) or (m, 2, 1, 2, n), respectively. The compound having formula (III) or (IV) can be selected from a group consisting of compound (10, 2, 0, 2, 10), compound (11, 2, 0, 2, 11), compound (12, 2, 0, 2, 12), compound (13, 2, 0, 2, 13), compound (14, 2, 0, 2, 14), compound (10, 2, 0, 2, 11), compound (10,2, 0, 2, 12), compound (10, 2, 0, 2, 13), compound (10, 2, 0, 2, 14), compound (11, 2, 0, 2, 12), compound (11, 2, 0, 2, 13), compound (11, 2, 0, 2, 14), compound (12, 2, 0, 2, 13), compound (12, 2, 0, 2, 14), compound (13, 2, 0, 2, 14), compound (10, 2, 1, 2, 10), compound (11, 2, 1, 2, 11), compound (12, 2, 1, 2, 12), compound (13, 2, 1, 2, 13), compound (14, 2, 1, 2, 14), compound (10, 2, 1, 2, 11), compound (10,2, 1, 2, 12), compound (10, 2, 1, 2, 13), compound (10, 2, 1, 2, 14), compound (11, 2, 1, 2, 12), compound (11, 2, 1, 2, 13), compound (11, 2, 1, 2, 14), compound (12, 2, 1, 2, 13), compound (12, 2, 1, 2, 14) and compound (13, 2, 1, 2, 14).

The present disclosure also provide a method of making an antimicrobial composition, comprising mixing an effective amount of a compound having the formula (III) or (IV) and a carrier. The antimicrobial composition can also comprise other ingredients and additives. The present disclosure also provide a method of using the composition comprising a compound having the formula (III) or (IV) as described for antimicrobial use. The compound or the composition is used to kill or inhibit growth of at least one group of microorganisms selected from the group consisting of bacteria, viruses, yeast, fungi, and protozoa. The method may also comprises killing or dispersing pre-established bacterial biofilms (i.e. antibiofilm use). The method may comprise forming a film or coating comprising the antimicrobial composition comprising a compound having formula (III) or (IV), which can be grafted onto a solid surface.

In another aspect, the present disclosure provides a film or coating comprising a compound having formula (III) or (IV) grafted onto a solid surface having a structure:

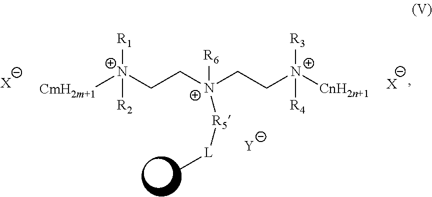

wherein R₁, R₂, R₃, R₄, or R₆ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

R₅^{′} is a chemical alkylene moiety unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

R′ is H or a C₁₋₄ alkyl,

X or Y is a halogen,

m and n are integers in the range from 5 to 25, and

L is a linker comprising a functional group.

In some embodiments, R₁, R₂, R₃, R₄ or R₆ is H or a C₁₋₄ alkyl unsubstituted such as methyl, R₅′ is a C₁₋₄ alkylene, and X or Y is fluorine, chlorine, bromine, iodine tosylate, citrate, any suitable anions or combinations thereof. m can be equal to or different from n. m and n can be integers in the range from 10 to 14. For example, R₁, R₂, R₃, R₄ or R₆ is methyl, R₅′ is methylene, X is bromine, and Y is iodine. L may comprise at least one of —NH—CO—, —C(O)— and an alkylene group. The film or coating is configured to kill or inhibit growth of at least one group of microorganisms selected from the group consisting of bacteria, viruses, yeast, fungi, and protozoa, or to kill, eradicate or disperse pre-established biofilms.

### DETAILED DESCRIPTION

Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. The present invention is not limited by the illustrated ordering of acts or events, as some acts may occur in different orders and/or concurrently with other acts or events. Furthermore, not all illustrated acts or events are required to implement a methodology in accordance with the present invention.

### DEFINITIONS

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed.

The term “antimicrobial” refers to an ability to kill or inhibit the growth of microorganisms, including but are not limited to bacteria, viruses, yeast, fungi, and protozoa, or to attenuate the severity of a microbial infection. The antimicrobial compounds or compositions of the present invention are compounds or compositions that may be used for cleaning or sterilization, or may be used in the treatment of disease and infection. The applications may include both in vitro and in vivo antimicrobial uses. “Applying” an antimicrobial composition may include administrating a composition into a human or animal subject.

The term “biofilm” as used herein refer to a film formed by a group of microorganisms adhered together. The term “antibiofilm” as used herein refer to an ability to kill and/or eradicate or disperse a pre-established biofilm.

The term “alkyl” as used herein refers to a straight chain, cyclic, branched or unbranched saturated or unsaturated hydrocarbon chain containing 1-25 carbon atoms, such as methyl, ethyl, propyl, tert-butyl, n-hexyl and the like. “A C₁₋₄ alkyl” as used herein refers to an alkyl group having a number of carbon atoms selected from 1 to 4.

The term “optionally substituted” means that group in question may be unsubstituted or it may be substituted one or several times, such as 1 to 3 times or 1 to 5 times. For example, an alkyl group that is “optionally substituted” with 1 to 5 chloro atoms, may be unsubstituted, or it may contain 1, 2, 3, 4, or 5 chlorine atoms. Substituted chemical moieties include one or more substituents that replace hydrogen.

The present disclosure provides an antimicrobial composition comprising a compound which is a biscationic or triscationic amphiphile, and the method of making such an antimicrobial composition, and the method of using such a compound or composition for antimicrobial use. The compound or the composition provided in the disclosure has an ability to kill or inhibit the growth of microorganisms, including but are not limited to bacteria, viruses, yeast, fungi, and protozoa, or to attenuate the severity of a microbial infection.

1. Asymmetric Bi(Quaternary Ammonium) Halide:

Cationic amphiphiles have had a history in addressing the problem of bacterial resistance, highlighted by the introduction of benzalkonium chloride (N-alkyl-N-benzyl-N,N-dimethylammonium chloride) in the 1930s, and formulation of this series of structures into commercially important agents such as LYSOL® brand products.

Cationic amphiphiles have been regarded as membrane disruptors, capitalizing on electrostatic interactions with the predominantly anionic bacterial cell membrane, followed by intercalation of the non-polar chain, which leads to membrane disruption and ultimately bacterial cell lysis. It has been suggested that this mechanism may be minimally susceptible to bacterial resistance. Other mechanisms of action have been identified, including internalization of amphiphiles into bacterial cells.

A concern for the development of antimicrobial agents is economy of preparation. Many cationic amphiphiles benefit from facile assembly. Antimicrobial peptides and synthetic mimics thereof (SMAMPs), a promising group of structures which often serve as cationic amphiphiles, are oftentimes challenging to obtain or prepare, though improvements in this area are being sought. The inventors in the present disclosure have thus chosen to pursue the preparation of potent amphiphilic antimicrobials with high levels of atom economy, utilizing short and user-friendly preparations.

The inventors' research program has aimed to develop multi-headed (polycephalic) amphiphiles to optimize antibacterial action. A focus on asymmetric disposition of alkyl chains around an easily accessible bis-ammonium core has led to simple and efficient preparation of a series of amphiphiles with low micromolar activity. For example, starting with 4,4′-bipyridine, the inventors prepared symmetric and asymmetric amphiphiles. First, bioactivity peaked at an optimal number of alkyl carbons on the non-polar tails, roughly 22-24 side chain carbons. Less important was the nature of the counterion. Finally, modest amounts of asymmetry seemed to ensure good solubility of amphiphiles with longer alkyl chains.

In some embodiments, a series of readily available bis-amine structures are chosen as a synthetic core. For example, a bis-amine as a starting material is N,N,N′ N′-tetramethyl ethylenediamine (TMEDA), which is available at a cost of approximately $20/mol. Analogous structures with increased linker distance between the amines, as well as those with increased number of amines such as spermidine and spermine, are also available at reasonable cost. The structures of TMEDA, spermidine, spermine, and norspermidine derivatives are shown in Scheme 1. Some embodiments are also compared to norspermidine derivatives for antimicrobial ability.

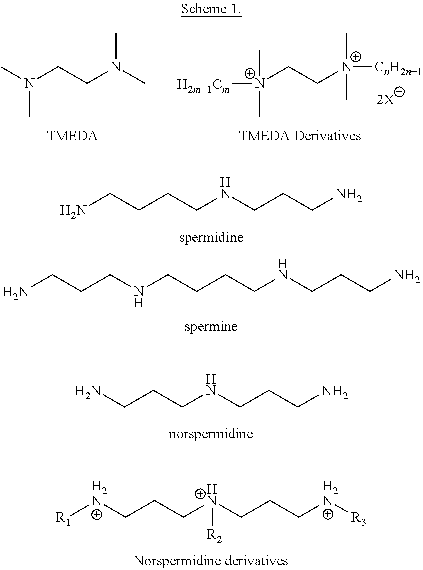

Some embodiments provide a method of killing or inhibiting microbial growth, comprising applying an antimicrobial composition comprising a compound having the formula

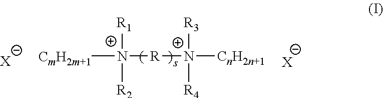

wherein R is a methylene group unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

s is an integer in the range from 1 to 6,

R₁, R₂, R₃ or R₄ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

R′ is H or a C₁₋₄ alkyl,

X is a halogen (in the form of anion),

each of m and n is an integer in the range from 5 to 25, and m is not equal to n.

For example, in some embodiments, R is a methylene group, and s is an integer in the range from 2 to 5. R₁, R₂, R₃ or R₄ is a C₁₋₄ alkyl, and X is fluorine, chlorine, bromine, iodine, tosylate, citrate, any suitable anion or any combinations thereof. The compound having the formula (I) is an asymmetric bi(quaternary ammonium) halide because m is not the same as n. The halide can be fluoride, chloride, bromide, iodide, or any combination thereof. In some embodiments, a moderate asymmetry is preferred. The difference between m and n may be in the range from 1 to 8.

In some embodiments, the antimicrobial composition comprises a compound having the formula

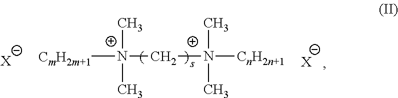

denoted as compound (m, s, n) halide, wherein s is an integer in the range from 1 to 6, X is a halogen or a combination thereof, m and n are integers in the range from 5 to 25, and m is not equal to n. The a compound having the formula (II) is a bi(quaternary ammonia) halide having an asymmetric structure. For example, s is an integer in the range from 2 to 5, and X is chlorine or bromine (in the form of chloride or bromide ion).

The numbers of carbon atoms m and n can be in different combinations. For example, in some embodiments, m+n is in the range of from 18 to 36, and the difference between m and n is in the range from 1 to 10. The compound having the formula (II) denoted as a compound (m, s, n) halide can be a bromide. Examples of such a compound include but are not limited to compound (20, 2, 16), compound (20, 2, 14), compound (20, 2, 14), compound (20, 2, 10), compound (20, 2, 8), compound (20, 2, 6), compound (18, 2, 16), compound (18, 2, 14), compound (18, 2, 12), compound (18, 2, 10), compound (16, 2, 8), compound (14, 2, 12), compound (14, 2, 10), compound (14, 2, 8), compound (12, 2, 10), compound (12, 2, 8), compound (13, 2, 10), compound (13, 2, 10), compound (10, 2, 8) and combinations thereof.

In some embodiments, m+n is in the range of from 20 to 24. The compound having the formula (II) may have a moderate asymmetry. For example, the difference between m and n may be in the range from 1 to 8. The compound having the formula (II) denoted as compound (m, s, n) halide can be a bromide. Examples of a suitable bromide compound include but are not limited to compound (16, 2, 8), compound (14, 2, 10), compound (14, 2, 8), compound (12, 2, 10), compound (12, 2, 8), compound (13, 2, 10) and compound (11, 2, 10).

The antimicrobial compositions described can be used to kill or inhibit growth of at least one group of microorganisms selected from the group consisting of bacteria, viruses, yeast, fungi, and protozoa. The method described comprising “applying” an antimicrobial composition may include spraying the antimicrobial composition onto an area, wiping a solid surface with the antimicrobial composition, or administrating a composition into a human or animal subjects, any other suitable applying methods, and combinations thereof. The method can be used for prevention of infectious conditions, or used as a method for treating infectious conditions with the antimicrobial composition provided in the disclosure. The method can be also used to kill, eradicate or disperse pre-established bacterial biofilms (i.e. antibiofilm use).

In some embodiments, the present disclosure also provides an antimicrobial composition comprising a compound having the formula (I) as described, and a carrier such as a solvent. The antimicrobial composition can also comprise other ingredients and additives. In some embodiments, the compound having the formula (I) in such an antimicrobial composition is a compound having the formula (II) denoted as compound (m, s, n) halide as described. The content of the compound having the formula (I) or (II) can be in any suitable concentration. For example, in some embodiments, such a concentration can be in the range from 0.01 μM to 100 μM, for example, from 0.1 μM to 10 μM. In some embodiments, the content of the compound having the formula (I) or (II) may be at a concentration of from 0.1 wt. % to 5 wt. %, for example, in the range of from 0.2 wt. % to 2.5 wt. %. Examples of the carrier include but are not limited to a solvent. Examples of other additives include but are not limited to surfactants, anti-foaming agents, anti-freezing agents, gelling agents, and combinations thereof. The antimicrobial composition may also comprise a pharmaceutically acceptable carrier or excipient. A pharmaceutically acceptable carrier or excipient suitable for a solid preparation such as tablets or capsules can be, for example, binders (e.g., acacia, gelatin, dextrin, hydroxypropylcellulose, methylcellulose, polyvinylpyrrolidone), solvents, dispersion media, diluents (e.g., lactose, sucrose, mannitol, corn starch, potato starch, calcium phosphate, calcium citrate, crystalline cellulose), lubricants (e.g., magnesium stearate, calcium stearate, stearic acid, talc, anhydrous silicic acid), disintegrants (e.g., corn starch, potato starch, carboxymethylcellulose, carboxymethylcellulose calcium, alginic acid), and wetting agents (e.g., sodium laurylsulfate). A pharmaceutically acceptable carrier or excipient suitable for a liquid preparation, such as solutions or suspensions, can be, for example, aqueous vehicles (e.g., water), suspending agents (e.g., acacia, gelatin, methyl cellulose, carboxymethylcellulose sodium, hydroxymethyl-cellulose, aluminum stearate gel), surfactants (e.g., lecithin, sorbitan monooleate, glycerin monostearate), and non-aqueous vehicles (e.g., glycerin, propylene glycol, vegetable oil). Moreover, liquid preparations may contain preservatives (e.g., p-hydroxybenzoic acid methyl ester, p-hydroxybenzoic acid propyl ester), flavors, and/or coloring agents. The antimicrobial composition in this disclosure can be formulated to be in any suitable form, including but not limited to liquid, gel and paste.

The present disclosure also provides a method of making an antimicrobial composition comprising mixing a compound having the formula (I) and a carrier such as a solvent. In some embodiments, such a method comprising mixing a carrier or other ingredients and a compound having the formula (II) denoted as compound (m, s, n) halide as described.

### Examples

A series of asymmetric bis-alkylated TMEDA derivatives have been prepared. Such asymmetric bis-alkylated TMEDA derivatives show powerful antimicrobial activities.

Monoalkylation of TMEDA can be accomplished in a straightforward and atom-economical manner, with exposure of a modest excess (2 molar equivalents) of the bisamine to a variety of alkyl bromides in nearly solvent-free conditions (Scheme 2). Simple removal of excess TMEDA in vacuo leads to a substantially pure (>98%) monoalkylated crystalline product, which is denoted as compound (m,2,0), in nearly quantitative yields, without workup or chromatography.

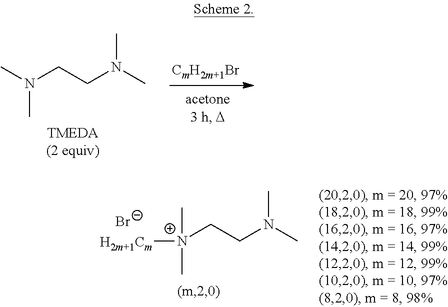

Subsequent exposure to a different alkyl bromide, again in nearly neat reaction conditions (˜1M in acetonitrile), followed by filtration, leads to good yields (˜40-90%) of the desired asymmetric biscationic amphiphiles, designated as (m,2,n), as shown in Scheme 3. Scheme 3 shows the route and yields of synthetic preparation of asymmetric bisalkylated TMEDA derivatives. Asterisk indicates a water-insoluble compound. Recrystallization was performed as necessary to ensure compound purity >98%, as determined by NMR and LCMS. It was found to be operationally advantageous to start with the longer-chained monocationic compounds for installation of the second chain, i.e., preparing (20,2,10) from (20,2,0) and not from (10,2,0). This perhaps reflects the hygroscopic nature of the smaller-chained compounds. A large-sized compound (20,2,18) suffered from poor water solubility; it was thus not evaluated for bioactivity.

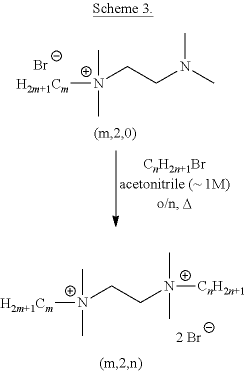

| | n of Alkyl bromide (CₙH₂ₙ₊₁Br) | | | | | |
|---|---|---|---|---|---|---|
| Starting material | 18 | 16 | 14 | 12 | 10 | 8 |
| (20, 2, 0) | 54%* | 77% | 81% | 73% | 82% | 84% |
| (18, 2, 0) | | 78% | 65% | 47% | 54% | 72% |
| (16, 2, 0) | | | 79% | 77% | 91% | 85% |
| (14, 2, 0) | | | | 43% | 66% | 70% |
| (12, 2, 0) | | | | | 63% | 69% |
| (10, 2, 0) | | | | | | 47% |

Additionally, two compounds with odd numbers of carbons in one chain, compound (13,2,10) and compound (11,2,10), were prepared from compound (10,2,0). The corresponding yields were comparable to the other preparations (Scheme 4). Scheme 4 illustrates synthetic preparation of asymmetric bisalkylated TMEDA derivatives with odd-numbered alkyl side chains.

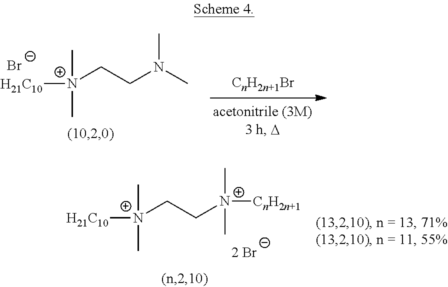

For comparative purposes, symmetrical TMEDA amphiphiles were prepared according to literature precedent (Scheme 5). Scheme 5 shows synthetic preparation of symmetric (gemini) bisalkylated TMEDA derivatives. Thus, exposure of TMEDA to excess alkyl bromide (3 equivalent) in acetonitrile, followed by filtration, led to (n,2,n) compounds, which were recrystallized as necessary.

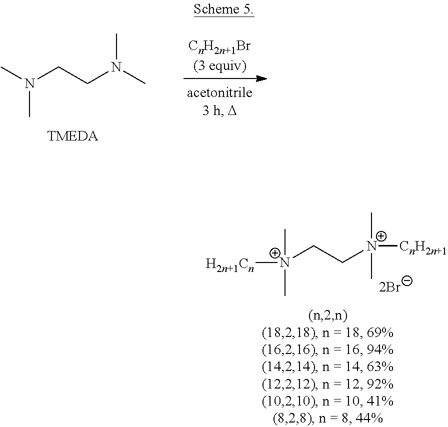

Preparation of some exemplary compounds and comparative compounds are described as follows.

Compound (20,2,16) Bromide:

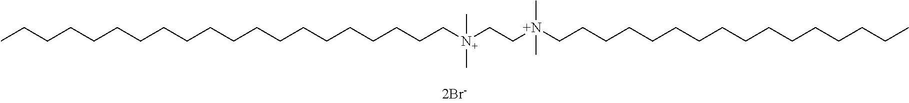 [SMILES: CCCCCCCCCCCCCCCCCCCC[N+](C)(C)CC[N+](C)(C)CCCCCCCCCCCCCCCC]

To a solution of (20, 2, 0) (300 mg, 0.629 mmol) in CH₃CN (0.40 mL) was added 1-bromohexadecane (0.58 mL, 1.9 mmol). The resulting clear solution was warmed to reflux with stirring for 3 h; on cooling to room temperature (RT) a yellow solid was observed. Cold acetone (˜9 mL) was added to the RT reaction mixture, which was then cooled to 0° C., leading to a white precipitate. Filtration through a Buchner funnel furnished an off-white solid, which was washed with cold acetone (˜4 mL) and then hexanes (˜4 mL). The off-white solid was recrystallized from CH₂Cl₂ (˜10 mL) affording (20,2,16) (192 mg, 39%) as a white powder: mp 193.0-196.0° C.; ¹H NMR (300 MHz, CDCl₃) δ 4.77 (s, 4H), 3.74-3.68 (m, 4H), 3.49 (s, 12H), 1.79 (br s, 4H), 1.39-1.25 (m, 60H), 0.88 (t, J=6.0 Hz, 6H); low resolution mass spectrum (ESI) m/z 311.6 [M²⁺; calcd for C₄₂H₉₀N₂: 311.36].

Compound (20,2,14) Bromide:

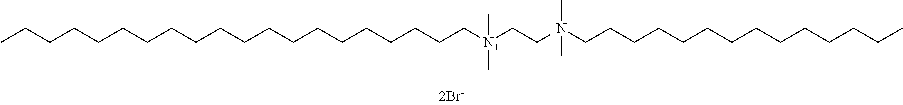 [SMILES: CCCCCCCCCCCCCCCCCCCC[N+](C)(C)CC[N+](C)(C)CCCCCCCCCCCCCC]

To a solution of (20, 2, 0) (300 mg, 0.629 mmol) in CH₃CN (0.63 mL) was added 1-bromotetradecane (0.15 mL, 0.63 mmol). The resulting clear solution was warmed to reflux with stirring for 19 h, during which time a yellow color was observed. To the warm reaction mixture was added cold acetone (˜9 mL), and the reaction mixture was cooled to 0° C., which led to a white precipitate. Filtration through a Buchner funnel furnished a white solid, which was washed with cold acetone (˜4 mL) and then hexanes (˜4 mL), affording (20,2,14) (385 mg, 81%) as a white powder: mp 194.0-198.0° C.; ¹H NMR (300 MHz, CDCl₃) δ 4.82 (s, 4H), 3.76-3.68 (m, 4H), 3.50 (s, 12H), 1.77 (br s, 4H), 1.44-1.22 (m, 56H), 0.88 (t, J=6.9 Hz, 6H); low resolution mass spectrum (ESI) m/z 297.6 [M²⁺; calcd for C₄₀H₈₆N₂: 297.34].

Compound (20,2,12) Bromide:

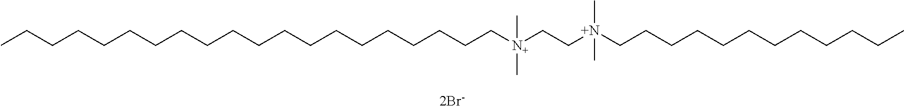 [SMILES: CCCCCCCCCCCCCCCCCCCC[N+](C)(C)CC[N+](C)(C)CCCCCCCCCCCC]

To a solution of (20,2,0) (300 mg, 0.629 mmol) in CH₃CN (0.63 mL) was added 1-bromododecane (0.15 mL, 0.62 mmol). The resulting clear solution was warmed to reflux with stirring for 19 h, during which time a yellow solid was observed. To the warm reaction mixture was added cold acetone (˜9 mL), and the reaction mixture was cooled to 0° C., which led to a light-yellow precipitate. Filtration through a Buchner funnel furnished a white solid, which was washed with cold acetone (˜4 mL) and then hexanes (˜4 mL), affording (20,2,12) (334 mg, 73%) as a white powder: mp 194.0-198.0° C.; ¹H NMR (300 MHz, CDCl₃) δ 4.78 (s, 4H), 3.74-3.69 (m, 4H), 3.50 (s, 12H), 1.80 (br s, 4H), 1.42-1.22 (m, 52H), 0.88 (t, J=7.2 Hz, 6H); low resolution mass spectrum (ESI) m/z 283.6 [M²⁺; calcd for C₃₈H₈₂N₂: 283.33].

Compound (20,2,10) Bromide:

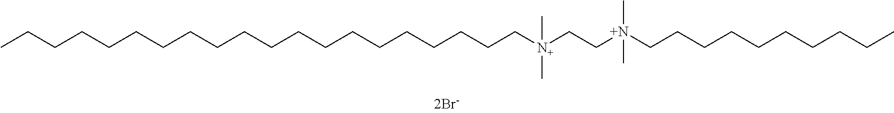 [SMILES: CCCCCCCCCCCCCCCCCCCC[N+](C)(C)CC[N+](C)(C)CCCCCCCCCC]

To a solution of (20,2,0) (300 mg, 0.629 mmol) in CH₃CN (0.63 mL) was added 1-bromodecane (0.16 mL, 0.77 mmol). The resulting clear solution was warmed to reflux with stirring for 23 h. To the warm reaction mixture was added cold acetone (˜9 mL), and the reaction mixture was cooled to 0° C., which led to a white precipitate. Filtration through a Buchner funnel furnished a white solid, which was washed with cold acetone (˜4 mL) and then hexanes (˜4 mL), affording (20,2,10) (362 mg, 82%) as a white powder: mp 195.0-196.0° C.; ¹H NMR (300 MHz, CDCl₃) δ 4.70 (s, 4H), 3.73-3.65 (m, 4H), 3.49 (s, 12H), 1.78 (br s, 4H), 1.40-1.20 (m, 48H), 0.87 (t, J=6.3 Hz, 6H); low resolution mass spectrum (ESI) m/z 269.5 [M²⁺; calcd for C₃₆H₇₈N₂: 269.31].

Compound (20,2,8) Bromide:

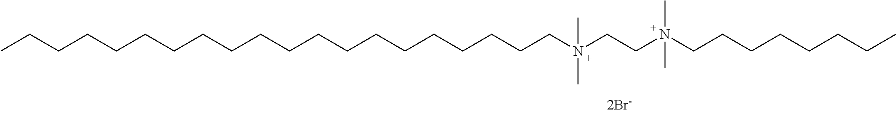

To a solution of (20,2,0) (301 mg, 0.630 mmol) in CH₃CN (0.63 mL) was added 1-bromooctane (0.08 mL, 0.6 mmol). The resulting clear solution was warmed to reflux with stirring for 22 h, during which time a yellow color was observed. To the warm reaction mixture was added cold acetone (˜9 mL), and the reaction mixture was cooled to 0° C., which led to a white precipitate. Filtration through a Buchner funnel furnished a white powder, which was washed with cold acetone (˜4 mL) affording (20,2,8) (354 mg, 88%) as a white powder: mp 193.0-198.0° C.; ¹H NMR (300 MHz, CDCl₃) δ 4.80 (s, 4H), 3.76-3.67 (m, 4H), 3.50 (s, 12H), 1.78 (br s, 4H), 1.42-1.22 (m, 44H), 0.88 (t, J=6.3 Hz, 6H); low resolution mass spectrum (ESI) m/z 255.5 [M²⁺; calcd for C₃₄H₇₄N₂: 255.29].

Compound (20,2,6) Bromide

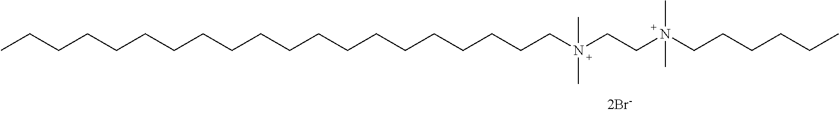

To a solution of (20, 2, 0) (301 mg, 0.63 mmol) in CH₃CN (0.63 mL) was added 1-bromohexane (0.09 mL, 0.6 mmol). The resulting clear solution was warmed to reflux with stirring for 22 h, during which time a yellow color was observed. To the warm reaction mixture was added cold acetone (˜9 mL), and the reaction mixture was cooled to 0° C., which led to a light-yellow precipitate. Filtration through a Buchner funnel furnished an light-yellow solid, which was washed with cold acetone (˜4 mL) and then hexanes (˜4 mL), affording (20,2,6) (249 mg, 62%) as an off-white powder: mp 195.0-196.0° C.; ¹H NMR (300 MHz, CDCl₃) δ 4.78 (s, 4H), 3.75-3.66 (m, 4H), 3.49 (s, 12H), 1.78 (br s, 4H), 1.44-1.20 (m, 40H), 0.88 (t, J=7.7 Hz, 6H); low resolution mass spectrum (ESI) m/z 241.5 [M²⁺; calcd for C₃₂H₇₀N₂: 241.28].

Comparative Compound (18,2,18) Bromide

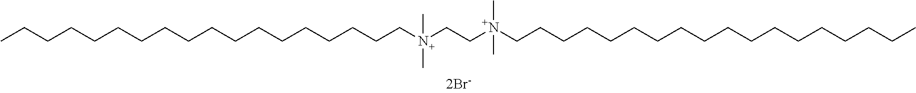

To a solution of 1-bromooctadecane (2.555 g, 7.664 mmol) in CH₃CN (0.64 mL) was added N,N,N′,N′-tetramethylethylenediamine (0.38 mL, 2.5 mmol). The resulting clear solution was warmed to reflux with stirring for 3 h, during which time a pale-yellow solid was observed. To the warm reaction mixture was added cold acetone (˜9 mL), and the reaction mixture was cooled to 0° C., which led to an off-white precipitate. Filtration through a Buchner funnel furnished an off-white powder, which was washed with cold acetone (˜8 mL). The off-white solid was recrystallized from CH₂Cl₂ (˜40 mL) affording (18,2,18) (1.367 g, 69%) as a white powder: mp 186.0-188.0° C.; ¹H NMR (300 MHz, CDCl₃) δ 4.78 (s, 4H), 3.74-3.68 (m, 4H), 3.49 (s, 12H), 1.78 (br s, 4H), 1.42-1.19 (m, 60H), 0.87 (t, J=5.7 Hz, 6H); low resolution mass spectrum (ESI) m/z 311.6 [M²⁺; calcd for C₄₂H₉₀N₂: 311.36].

Compound (18,2,16) Bromide:

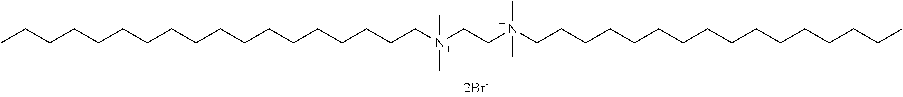

To a solution of (18,2,0) (300 mg, 0.667 mmol) in CH₃CN (0.34 mL) was added 1-bromohexadecane (0.61 mL, 2.0 mmol). The resulting clear solution was warmed to reflux with stirring for 3 h. To the warm reaction mixture was added cold acetone (˜9 mL), and the reaction mixture was cooled to 0° C., which led to a white precipitate. Filtration through a Buchner funnel furnished a white solid, which was washed with cold acetone (˜4 mL) and then hexanes (˜4 mL). The off-white solid was recrystallized from CH₂Cl₂ (˜10 mL) affording (18,2,16) (392 mg, 78%) as a white powder: 196.0-198.0° C.; ¹H NMR (300 MHz, CDCl₃) δ 4.59 (s, 4H), 3.72-3.64 (m, 4H), 3.46 (s, 12H), 1.76 (br s, 4H), 1.41-1.21 (m, 56H), 0.88 (t, J=7.5 Hz, 6H); low resolution mass spectrum (ESI) m/z 297.6 [M²⁺; calcd for C₄₀H₈₆N₂: 297.34].

Compound (18,2,14) Bromide:

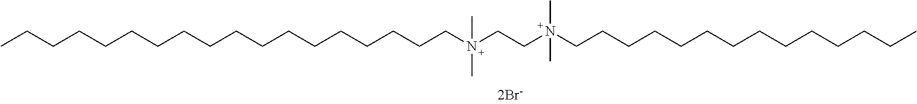

To a solution of (18,2,0) (301 mg, 0.669 mmol) in CH₃CN (0.17 mL) was added 1-bromotetradecane (0.55 mL, 2.0 mmol). The resulting clear solution was warmed to reflux with stirring for 3 h, during which time a yellow solid was observed. Cold acetone (˜9 mL) was added to the rt reaction mixture, which was then cooled to 0° C., leading to a white precipitate. Filtration through a Buchner funnel furnished an off-white solid, which was washed with cold acetone (˜4 mL) and then hexanes (˜4 mL). The off-white solid was recrystallized from CH₂Cl₂ (˜10 mL) affording (18,2,14) (469 mg, 65%) as a white powder: mp 194.0-196.0° C.; ¹H NMR (300 MHz, CDCl₃) δ 4.68 (s, 4H), 3.73-3.67 (m, 4H), 3.49 (s, 12H), 1.75 (br s, 4H), 1.37-1.25 (m, 52H), 0.88 (t, J=6.3 Hz, 6H); mp 194.0-196.0° C.; low resolution mass spectrum (ESI) m/z 283.4 [M²⁺; calcd for C₃₈H₈₂N₂: 283.33].

Compound (18,2,12) Bromide:

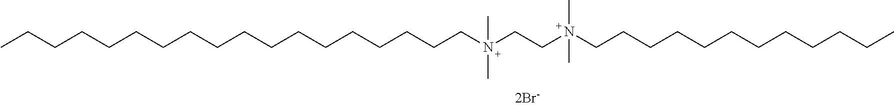

To a solution of (18,2,0) (300 mg, 0.667 mmol) in CH₃CN (0.17 mL) was added 1-bromododecane (0.55 mL, 2.0 mmol). The resulting clear solution was warmed to reflux with stirring for 3 h, during which time a yellow solid was observed. Cold acetone (˜9 mL) was added to the rt reaction mixture, which was then cooled to 0° C., leading to a white precipitate. Filtration through a Buchner funnel furnished an off-white solid, which was washed with cold acetone (˜4 mL) and then hexanes (˜4 mL). The off-white solid was recrystallized from CH₂Cl₂ (˜10 mL) affording (18,2,12) (217 mg, 47%) as a white powder: 189.0-194.0° C.; ¹H NMR (300 MHz, CDCl₃) δ 4.76 (s, 4H), 3.74-3.68 (m, 4H), 3.50 (s, 12H), 1.78 (br s, 4H), 1.42-1.20 (m, 48H), 0.88 (t, J=6.9 Hz, 6H); low resolution mass spectrum (ESI) m/z 269.4 [M²⁺; calcd for C₃₆H₇₈N₂: 269.31].

Compound (18,2,10) Bromide:

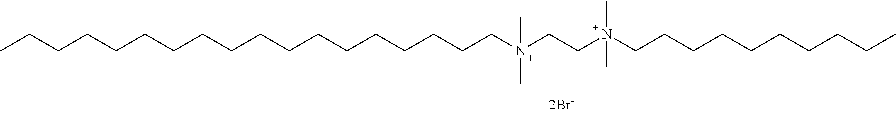

To a solution of (18,2,0) (301 mg, 0.669 mmol) in CH₃CN (0.33 mL) was added 1-bromodecane (0.42 mL, 2.0 mmol). The resulting clear solution was warmed to reflux with stirring for 3 h, during which time a solid was observed. Cold acetone (˜9 mL) was added to the rt reaction mixture, which was then cooled to 0° C., leading to a white precipitate. Filtration through a Buchner funnel furnished an off-white solid, which was washed with cold acetone (˜4 mL) and then hexanes (˜4 mL). The white solid was recrystallized from CH₂Cl₂ (˜10 mL) affording (18,2,10) (241 mg, 54%) as a white powder: 191.0-195.0° C.; ¹H NMR (300 MHz, CDCl₃) δ 4.76 (s, 4H), 3.74-3.68 (m, 4H), 3.50 (s, 12H), 1.80 (br s, 4H), 1.41-1.20 (m, 44H), 0.88 (t, J=6.9 Hz, 6H); low resolution mass spectrum (ESI) m/z 255.5 [M²⁺; calcd for C₃₄H₇₄N₂: 255.29].

Compound (18,2,8) Bromide:

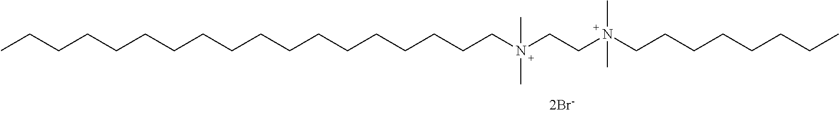

To a solution of (18,2,0) (301 mg, 0.67 mmol) in CH₃CN (0.17 mL) was added 1-bromooctane (0.17 mL, 0.98 mmol). The resulting clear solution was warmed to reflux with stirring for 3 h. Cold acetone (˜9 mL) was added to the RT reaction mixture, which was then cooled to 0° C., leading to a white precipitate. Filtration through a Buchner funnel furnished an white solid, which was washed with cold acetone (˜4 mL) and then hexanes (˜4 mL), affording (18,2,8) (310 mg, 72%) as a white powder: mp 193.0-197.0° C.; ¹H NMR (300 MHz, CDCl₃) δ 4.71 (s, 4H), 3.74-3.65 (m, 4H), 3.49 (s, 12H), 1.80 (br s, 4H), 1.41-1.20 (m, 40H), 0.87 (t, J=5.7 Hz, 6H); low resolution mass spectrum (ESI) m/z 241.5 [M²⁺; calcd for C₃₂H₇₀N₂: 241.28].

Comparative Compound (16,2,16) Bromide:

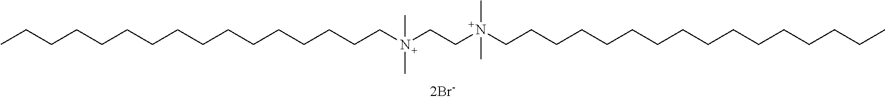

To a solution of 1-bromohexadecane (2.50 mL, 8.11 mmol) in CH₃CN (0.64 mL) was added N,N,N′,N′-tetramethylethylenediamine (0.42 mL, 2.9 mmol). The resulting clear yellow solution was warmed to reflux with stirring for 2 h. To the warm reaction mixture was added cold acetone (˜4 mL), and the reaction mixture was cooled to 0° C., which led to a white precipitate. Filtration through a Buchner funnel furnished an off-white powder, which was washed with cold acetone (˜4 mL) affording (16,2,16) (1.882 g, 94%) as a white powder: 191.0-197.0° C.; ¹H NMR (300 MHz, CDCl₃) δ 4.75 (s, 4H), 3.74-3.66 (m, 4H), 3.49 (s, 12H), 1.78 (br s, 4H), 1.42-1.21 (m, 52H), 0.88 (t, J=6.9 Hz, 6H); low resolution mass spectrum (ESI) m/z 283.6 [M²; calcd for C₃₈H₈₂N₂: 283.33].

Compound (16,2,14) Bromide:

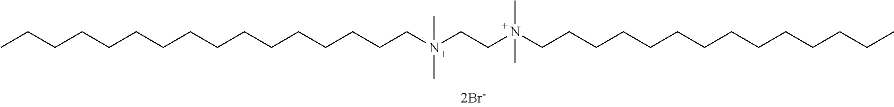

To a solution of (16,2,0) (299 mg, 0.699 mmol) in CH₃CN (0.71 mL) was added 1-bromotetradecane (0.17 mL, 0.70 mmol). The resulting clear solution was warmed to reflux with stirring for 22 h, during which time a yellow solid was observed. To the warm reaction mixture was added cold acetone (˜9 mL), and the reaction mixture was cooled to 0° C., which led to a white precipitate. Filtration through a Buchner funnel furnished a white powder, which was washed with cold acetone (˜4 mL) and then hexanes (˜4 mL), affording (16,2,14) (397 mg, 80%) as an white powder: 196.0-203.0° C.; ¹H NMR (300 MHz, CDCl₃) δ 4.76 (s, 4H), 3.74-3.66 (m, 4H), 3.49 (s, 12H), 1.77 (br s, 4H), 1.41-1.16 (m, 48H), 0.88 (t, J=6.9 Hz, 6H); low resolution mass spectrum (ESI) m/z 269.5 [M²⁺; calcd for C₃₆H₇₈N₂: 269.31].

Compound (16,2,12) Bromide:

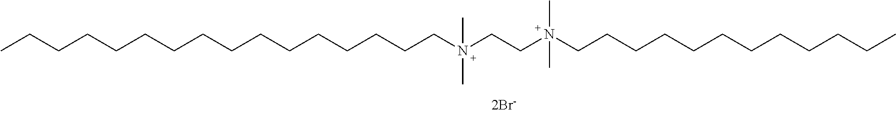

To a solution of (16,2,0) (300 mg, 0.712 mmol) in CH₃CN (0.71 mL) was added 1-bromododecane (0.17 mL, 0.70 mmol). The resulting clear solution was warmed to reflux with stirring for 20 h, during which time a yellow solid was observed. To the warm reaction mixture was added cold acetone (˜9 mL), and the reaction mixture was cooled to 0° C., which led to a white precipitate. Filtration through a Buchner funnel furnished a white powder, which was washed with cold acetone (˜4 mL) and then hexanes (˜4 mL), affording (16,2,12) (368 mg, 77%) as an white powder: 196.5-199.5° C.; ¹H NMR (300 MHz, CDCl₃) δ 4.73 (s, 4H), 3.74-3.65 (m, 4H), 3.49 (s, 12H), 1.78 (br s, 4H), 1.42-1.20 (m, 44H), 0.88 (t, J=6.3 Hz, 6H); low resolution mass spectrum (ESI) m/z 255.5 [M²⁺; calcd for C₃₄H₇₄N₂: 255.29].

Compound (16,2,10) Bromide:

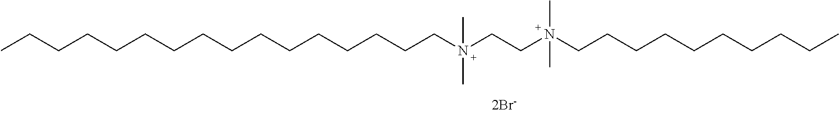

To a solution of (16,2,0) (300 mg, 0.712 mmol) in CH₃CN (0.71 mL) was added 1-bromodecane (0.15 mL, 0.73 mmol). The resulting clear solution was warmed to reflux with stirring for 20 h, during which time a yellow color was observed. To the warm reaction mixture was added cold acetone (˜9 mL), and the reaction mixture was cooled to 0° C., which led to a white precipitate. Filtration through a Buchner funnel furnished an white solid, which was washed with cold acetone (˜4 mL), affording (16,2,10) (415 mg, 91%) as a white powder: mp 195.0-199.0° C.; ¹H NMR (300 MHz, CDCl₃) δ 4.78 (s, 4H), 3.75-3.67 (m, 4H), 3.49 (s, 12H), 1.79 (br s, 4H), 1.46-1.20 (m, 40H), 0.88 (t, J=7.2 Hz, 6H); low resolution mass spectrum (ESI) m/z 241.5 [M²⁺; calcd for C₃₂H₇₀N₂: 241.28].

Compound (16,2,8) Bromide:

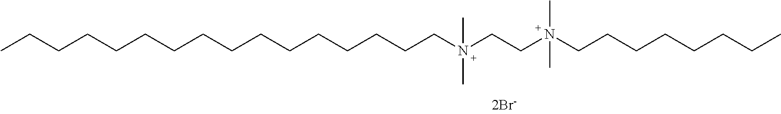

To a solution of (16,2,0) (300 mg, 0.712 mmol) in CH₃CN (0.71 mL) was added 1-bromooctane (0.12 mL, 0.69 mmol). The resulting clear solution was warmed to reflux with stirring for 20 h, during which time a yellow solid was observed. To the warm reaction mixture was added cold acetone (˜9 mL), and the reaction mixture was cooled to 0° C., which led to a white precipitate. Filtration through a Buchner funnel furnished an white solid, which was washed with cold acetone (˜4 mL) and then hexanes (˜4 mL), affording (16,2,8) (371 mg, 85%) as a white powder: mp 194.0-198.0° C.; ¹H NMR (300 MHz, CDCl₃) δ 4.78 (s, 4H), 3.74-3.69 (m, 4H), 3.50 (s, 12H), 1.79 (br s, 4H), 1.43-1.20 (m, 36H), 0.88 (t, J=6.6 Hz, 6H); low resolution mass spectrum (ESI) m/z 227.7 [M²⁺; calcd for C₃₀H₆₆N₂: 227.26].

Comparative Compound (14,2,14) Bromide:

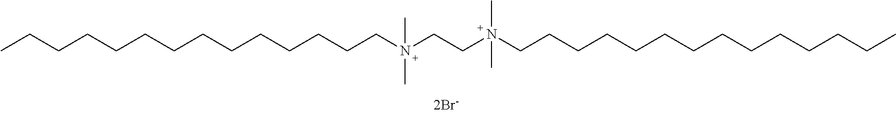

To a solution of 1-bromotetradecane (1.33 mL, 4.47 mmol) in CH₃CN (0.33 mL) was added N,N,N′,N′-tetramethylethylenediamine (0.22 mL, 1.5 mmol). The resulting clear solution was warmed to reflux with stirring for 2 h. To the warm reaction mixture was added cold acetone (˜4 mL), and the reaction mixture was cooled to 0° C., which led to a white precipitate. Filtration through a Buchner funnel furnished a white powder, which was washed with cold acetone (˜4 mL) and then hexanes (˜4 mL), affording (14,2,14) (623 mg, 62%) as a white powder: mp 194.5-197.0° C.; ¹H NMR (300 MHz, CDCl₃) δ 4.78 (s, 4H), 3.75-3.67 (m, 4H), 3.50 (s, 12H), 1.79 (br s, 4H), 1.43-1.21 (m, 44H), 0.88 (t, J=6.9 Hz, 6H); low resolution mass spectrum (ESI) m/z 255.4 [M²; calcd for C₃₄H₇₄N₂: 255.29].

Compound (14,2,12) Bromide:

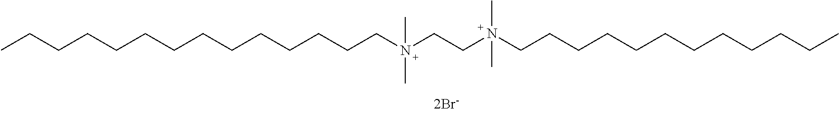

To a solution of (14,2,0) (301 mg, 0.765 mmol) in CH₃CN (0.76 mL) was added 1-bromododecane (0.18 mL, 0.74 mmol). The resulting clear solution was warmed to reflux with stirring for 19 h, during which time a yellow color was observed. To the warm reaction mixture was added cold acetone (˜9 mL), and the reaction mixture was cooled to 0° C., which led to a white precipitate. Filtration through a Buchner funnel furnished a white solid, which was washed with cold acetone (˜4 mL) and then hexanes (˜4 mL), affording (14,2,12) (203 mg, 43%) as a white powder: mp 196.0-199.0° C.; ¹H NMR (300 MHz, CDCl₃) δ 4.77 (s, 4H), 3.74-3.68 (m, 4H), 3.49 (s, 12H), 1.77 (br s, 4H), 1.41-1.22 (m, 40H), 0.88 (t, J=6.9 Hz, 6H); ¹³C NMR (75 MHz, CDCl₃) δ 65.65, 56.63, 51.60, 32.05, 29.88, 29.82, 29.52, 26.39, 23.20, 22.81, 14.24; low resolution mass spectrum (ESI) m/z 241.5 [M²⁺; calcd for C₃₂H₇₀N₂: 241.28].

Compound (14,2,10) Bromide:

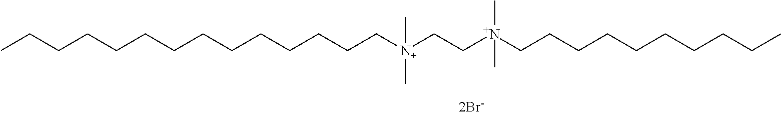 [SMILES: CCCCCCCCCCCCCC[N+](C)(C)CC[N+](C)(C)CCCCCCCCCC]

To a solution of (14,2,0) (301 mg, 0.765 mmol) in CH₃CN (0.40 mL) was added 1-bromodecane (0.16 mL, 0.77 mmol). The resulting clear solution was warmed to reflux with stirring for 17 h, during which time a yellow solid was observed. To the warm reaction mixture was added cold acetone (˜9 mL), and the reaction mixture was cooled to 0° C., which led to a white precipitate. Filtration through a Buchner funnel furnished a white powder, which was washed with cold acetone (˜4 mL) and then hexanes (˜4 mL), affording (14,2,10) (309 mg, 66%) as an off-white powder: mp 191.5-197.0° C.; ¹H NMR (300 MHz, CDCl₃) δ 4.77 (s, 4H), 3.74-3.68 (m, 4H), 3.50 (s, 12H), 1.79 (br s, 4H), 1.41-1.20 (m, 36H), 0.88 (t, J=6.6 Hz, 6H); ¹³C NMR (75 MHz, CDCl₃) δ 65.69, 56.65, 51.49, 32.00, 29.84, 29.78, 29.71, 29.67, 29.47, 29.44, 26.37, 23.17, 22.76, 14.20; low resolution mass spectrum (ESI) m/z 227.5 [M²⁺; calcd for C₃₀H₆₆N₂: 227.26].

Compound (14,2,8) Bromide:

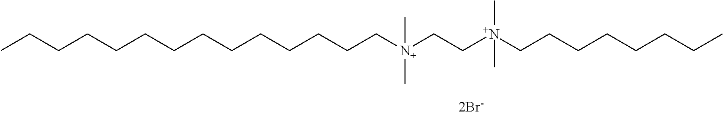 [SMILES: CCCCCCCCCCCCCC[N+](C)(C)CC[N+](C)(C)CCCCCCCC]

To a solution of (14,2,0) (300 mg, 0.762 mmol) in CH₃CN (0.76 mL) was added 1-bromooctane (0.13 mL, 0.75 mmol). The resulting clear solution was warmed to reflux with stirring for 19 h, during which time a dark-yellow solid was observed. To the warm reaction mixture was added cold acetone (˜9 mL), and the reaction mixture was cooled to 0° C., which led to a white precipitate. Filtration through a Buchner funnel furnished a white solid, which was washed with cold acetone (˜4 mL) and then hexanes (˜4 mL), affording (14,2,8) (311 mg, 70%) as a white solid: mp 184.0-186.0° C.; ¹H NMR (300 MHz, CDCl₃) δ 4.44 (s, 4H), 3.70-3.61 (m, 4H), 3.43 (s, 12H), 1.80 (br s, 4H), 1.42-1.22 (m, 32H), 0.88 (t, J=6.9 Hz, 6H); ¹³C NMR (75 MHz, CDCl₃) δ 65.59, 56.60, 51.55, 32.00, 31.82, 29.83, 29.78, 29.52, 29.46, 29.37, 29.29, 26.38, 23.16, 22.76, 22.73, 14.21; low resolution mass spectrum (ESI) m/z 213.4 [M²⁺; calcd for C₂₈H₆₂N₂: 213.25].

Compound (13,2,10) Compound:

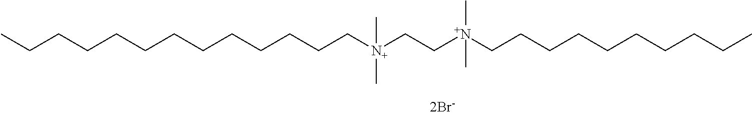 [SMILES: CCCCCCCCCCCCC[N+](C)(C)CC[N+](C)(C)CCCCCCCCCC]

To a solution of (10,2,0) (300 mg, 0.889 mmol) in CH₃CN (0.89 mL) was added 1-bromotridecane (0.23 mL, 0.90 mmol). The resulting clear solution was warmed to reflux with stirring for 18 h, during which time a light-yellow color was observed. To the warm reaction mixture was added cold acetone (˜9 mL), and the reaction mixture was cooled to 0° C., which led to a white precipitate. Filtration through a Buchner funnel furnished a white solid, which was washed with cold acetone (˜4 mL) and then hexanes (˜4 mL), affording (13,2,10) (380 mg, 71%) as an white solid: mp 194.0-196.0° C.; ¹H NMR (300 MHz, CDCl₃) δ 4.66 (s, 4H), 3.72-3.66 (m, 4H), 3.48 (s, 12H), 1.82 (br s, 4H), 1.41-1.20 (m, 34H), 0.88 (t, J=6.9 Hz, 6H); ¹³C NMR (75 MHz, CDCl₃) δ 65.61, 56.60, 51.49, 31.99, 31.96, 29.82, 29.76, 29.70, 29.65, 29.45, 26.34, 23.13, 22.74, 14.17; low resolution mass spectrum (ESI) m/z 220.3 [M²⁺; calcd for C₂₉H-₆₄N₂: 220.26].

Comparative Compound (12,2,12) Bromide:

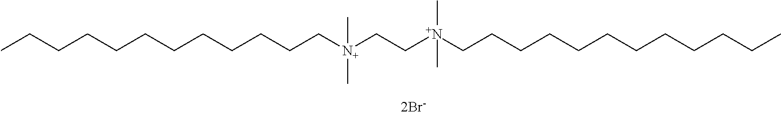 [SMILES: CCCCCCCCCCCC[N+](C)(C)CC[N+](C)(C)CCCCCCCCCCCC]

To a solution of 1-bromododecane (0.39 mL, 1.6 mmol) in CH₃CN (0.12 mL) was added N,N,N′,N′-tetramethylethylenediamine (0.080 mL, 0.53 mmol). The resulting clear solution was warmed to reflux with stirring for 2 h, during which time a pale-yellow solid was observed. To the warm reaction mixture was added cold acetone (˜9 mL), and the reaction mixture was cooled to 0° C., which led to a white precipitate. Filtration through a Buchner funnel furnished a white powder, which was washed with cold acetone (˜4 mL) and then hexanes (˜4 mL), affording (12,2,12) (306 mg, 92%) as a white powder: mp 189.0-194.0° C.; ¹H NMR (300 MHz, CDCl₃) δ 4.79 (s, 4H), 3.74-3.69 (m, 4H), 3.50 (s, 12H), 1.79 (br s, 4H), 1.38-1.25 (m, 36H), 0.88 (t, J=6.3 Hz, 6H); ¹³C NMR (75 MHz, CDCl₃) δ 65.87, 56.75, 51.28, 31.99, 29.78, 29.75, 29.69, 29.65, 29.46, 26.36, 23.16, 22.76, 14.21; low resolution mass spectrum (ESI) m/z 227.5 M²⁺; calcd for C₃₀H₆₆N₂: 227.26].

Compound (12,2,10) Bromide:

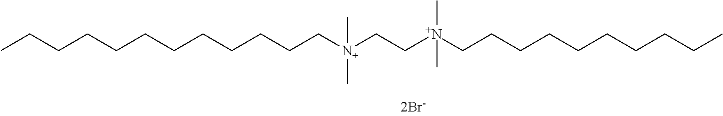 [SMILES: CCCCCCCCCCCC[N+](C)(C)CC[N+](C)(C)CCCCCCCCCC]

To a solution of (12,2,0) (300 mg, 0.821 mmol) in CH₃CN (0.41 mL) was added 1-bromodecane (0.17 mL, 0.82 mmol). The resulting clear solution was warmed to reflux with stirring for 17 h, during which time a light-yellow color was observed. To the warm reaction mixture was added cold acetone (˜9 mL), and the reaction mixture was cooled to 0° C., which led to a white precipitate. Filtration through a Buchner funnel furnished a white powder, which was washed with cold acetone (˜4 mL) and then hexanes (˜4 mL), affording (12,2,10) (305 mg, 63%) as an white solid: mp 189.0-192.0° C.; ¹H NMR (300 MHz, CDCl₃) δ 4.66 (s, 4H), 3.73-3.65 (m, 4H), 3.49 (s, 12H), 1.80 (br s, 4H), 1.41-1.21 (m, 32H), 0.88 (t, J=6.9 Hz, 6H); ¹³C NMR (75 MHz, CDCl₃) δ 65.52, 56.54, 51.63, 32.00, 29.84, 29.79, 29.70, 29.49, 26.36, 23.17, 22.78, 14.20; low resolution mass spectrum (ESI) m/z 212.5 [M²⁺; calcd for C₂₈H₆₂N₂: 213.25].

Compound (12,2,8) Bromide:

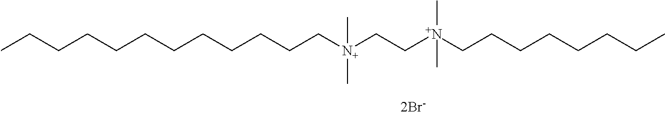 [SMILES: CCCCCCCCCCCC[N+](C)(C)CC[N+](C)(C)CCCCCCCC]

To a solution of (12,2,0) (303 mg, 0.829 mmol) in CH₃CN (0.41 mL) was added 1-bromooctane (0.11 mL, 0.83 mmol). The resulting clear solution was warmed to reflux with stirring for 19 h, during which time a yellow solid was observed. To the warm reaction mixture was added cold acetone (˜9 mL), and the reaction mixture was cooled to 0° C., which led to a white precipitate. Filtration through a Buchner funnel furnished a clear goo, which was washed with cold acetone (˜4 mL) and then hexanes (˜4 mL), affording (12,2,8) (203 mg, 43%) as a white powder: ¹H NMR (300 MHz, CDCl₃) δ 4.73 (s, 4H), 3.73-3.68 (m, 4H), 3.50 (s, 12H), 1.80 (br s, 4H), 1.41-1.22 (m, 28H), 0.88 (t, J=7.2 Hz, 6H); ¹³C NMR (75 MHz, CDCl₃) δ 65.86, 56.77, 51.30, 31.99, 31.79, 29.75, 29.44, 29.35, 29.24, 26.36, 23.14, 22.76, 22.70, 14.21; low resolution mass spectrum (ESI) m/z 199.3 [M²⁺; calcd for C₂₆H₅₈N₂: 199.23].

Compound (11,2,10) Bromide:

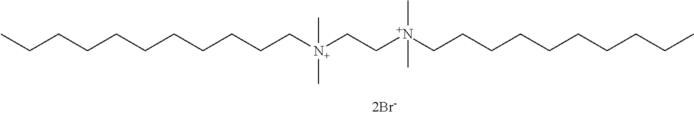 [SMILES: CCCCCCCCCCC[N+](C)(C)CC[N+](C)(C)CCCCCCCCCC]

To a solution of (10,2,0) (300 mg, 0.889 mmol) in CH₃CN (0.89 mL) was added 1-bromoundecane (0.20 mL, 0.90 mmol). The resulting clear solution was warmed to reflux with stirring for 22 h, during which time a dark-yellow solid was observed. Cold acetone (˜9 mL) was added to the rt reaction mixture, which was then cooled to 0° C., leading to a white precipitate. Filtration through a Buchner funnel furnished an white powder, which was washed with cold acetone (˜4 mL) and then hexanes (˜4 mL), affording (11,2,10) (279 mg, 55%) as a white powder: mp 179.0-180.0° C.; ¹H NMR (300 MHz, CDCl₃) δ 4.77 (s, 4H), 3.74-3.65 (m, 4H), 3.50 (s, 12H), 1.80 (br s, 4H), 1.42-1.21 (m, 30H), 0.88 (t, J=6.3 Hz, 6H); ¹³C NMR (75 MHz, CDCl₃) δ 65.64, 56.63, 51.45, 31.96, 29.70, 29.65, 29.44, 26.34, 23.14, 22.75, 13.17; low resolution mass spectrum (ESI) m/z 206.5 [M²⁺; calcd for C₂₇H₆₀N₂: 206.24].

Comparative Compound (10,2,10) Bromide:

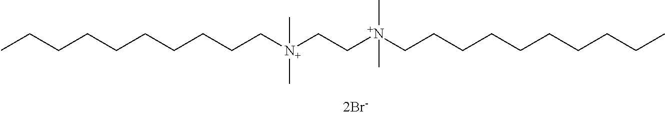 [SMILES: CCCCCCCCCC[N+](C)(C)CC[N+](C)(C)CCCCCCCCCC]

To a solution of 1-bromodecane (0.74 mL, 3.6 mmol) in CH₃CN (0.90 mL) was added N,N,N′,N′-tetramethylethylenediamine (0.27 mL, 1.8 mmol). The resulting clear solution was warmed to reflux with stirring for 17 h, during which time a dark-yellow solid was observed. To the warm reaction mixture was added cold acetone (˜9 mL), and the reaction mixture was cooled to 0° C., which led to a white precipitate. Filtration through a Buchner funnel furnished an off-white powder, which was washed with cold acetone (˜4 mL) and then hexanes (˜4 mL), affording (10,2,10) (414 mg, 41%) as an off-white powder: mp 133.0-137.0° C.; ¹H NMR (300 MHz, CDCl₃) δ 4.71 (s, 4H), 3.74-3.66 (m, 4H), 3.49 (s, 12H), 1.81 (br s, 4H), 1.41-1.22 (m, 28H), 0.88 (t, J=5.7 Hz, 6H); low resolution mass spectrum (ESI) m/z 199.3 [M²⁺; calcd for C₂₆H₅₈N₂: 199.23].

Compound (10,2,8) Bromide:

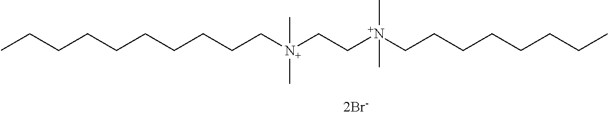 [SMILES: CCCCCCCCCC[N+](C)(C)CC[N+](C)(C)CCCCCCCC]

To a solution of (10,2,0) (300 mg, 0.889 mmol) in CH₃CN (0.89 mL) was added 1-bromooctane (0.15 mL, 0.87 mmol). The resulting clear solution was warmed to reflux with stirring for 22 h, during which time a yellow color was observed. To the warm reaction mixture was added cold acetone (˜9 mL), and the reaction mixture was cooled to 0° C., which led to a white precipitate. Filtration through a Buchner funnel furnished a white solid, which was washed with cold acetone (˜4 mL) and then hexanes (˜4 mL), affording (10,2,8) (224 mg, 47%) as a white solid: ¹H NMR (300 MHz, CDCl₃) δ 4.65 (s, 4H), 3.74-3.65 (m, 4H), 3.49 (s, 12H), 1.88 (br s, 4H), 1.45-1.21 (m, 24H), 0.88 (t, J=6.3 Hz, 6H); low resolution mass spectrum (ESI) m/z 185.3 [M²⁺; calcd for C₂₄H₅₄N₂: 185.25].

Comparative Compound [8,2,8) Bromide:

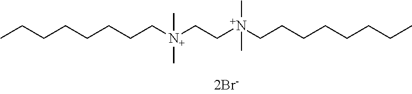 [SMILES: CCCCCCCC[N+](C)(C)CC[N+](C)(C)CCCCCCCC]

To a solution of 1-bromooctane (1.38 mL, 7.99 mmol) in CH₃CN (4 mL) was added N,N,N′,N′-tetramethylethylenediamine (0.60 mL, 4.0 mmol). The resulting clear solution was warmed to reflux with stirring for 18 h. To the warm reaction mixture was added cold acetone (˜9 mL), and the reaction mixture was cooled to 0° C., which led to a white precipitate. Filtration through a Buchner funnel furnished a white powder, which was washed with cold acetone (˜4 mL) and then hexanes (˜4 mL), affording (8,2,8) (874 mg, 43%) as a white powder. ¹H NMR (300 MHz, CDCl₃) δ 4.72 (s, 4H), 3.74-3.66 (m, 4H), 3.49 (s, 12H), 1.79 (br s, 4H), 1.43-1.23 (m, 20H), 0.88 (t, J=7.5 Hz, 6H); low resolution mass spectrum (ESI) m/z 171.5 [M²⁺; calcd for C₂₂H₅₀N₂: 171.20].

Compound (20,2,0) Bromide:

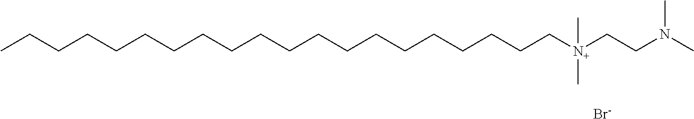 [SMILES: CCCCCCCCCCCCCCCCCCCC[N+](C)(C)CCN(C)C ; [Br-]]

To a solution of 1-bromoeicosane (1.513 g, 4.187 mmol) in acetone (2.2 mL) was added N,N,N′,N′-tetramethylethylenediamine (0.82 mL, 5.4 mmol). The resulting clear solution was warmed to reflux with stirring for 3 h. The reaction mixture was then concentrated in vacuo which led to a white precipitate. Filtration through a Buchner funnel furnished a white solid, which was washed with hexanes (˜4 mL), affording (20,2,0) (2.049 g, 102%) as a white solid: To a solution of 1-bromooctadecane (1.483 g, 4.448 mmol) in acetone (2.4 mL) was added N,N,N′,N′-tetramethylethylenediamine (1.34 mL, 8.88 mmol). The resulting clear solution was warmed to reflux with stirring for 3 h. The reaction mixture was then concentrated in vacuo affording (18,2,0) (1.999 g, 99%) as a white solid: mp 135.0-139.0° C.; ¹H NMR (300 MHz, CDCl₃) δ 3.82 (t, J=5.1 Hz, 2H), 3.62-3.57 (m, 2H), 3.44 (s, 6H), 2.76 (t, J=6 Hz, 2H), 2.29 (s, 6H), 1.72 (br s, 2H), 1.40-1.21 (m, 34H), 0.87 (t, J=6.3 Hz, 3H);); low resolution mass spectrum (ESI) m/z 397.3 [M⁺; calcd for C₂₆H₅₇N₂: 397.45].

Compound (18,2,0) bromide:

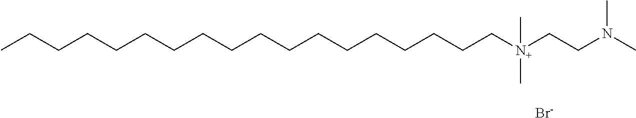 [SMILES: CCCCCCCCCCCCCCCCCC[N+](C)(C)CCN(C)C ; [Br-]]

To a solution of 1-bromooctadecane (1.483 g, 4.448 mmol) in acetone (2.4 mL) was added N,N,N′,N′-tetramethylethylenediamine (1.34 mL, 8.89 mmol). The resulting clear solution was warmed to reflux with stirring for 3 h. The reaction mixture was then concentrated in vacuo affording (18,2,0) (1.999 g, 99%) as a white solid: mp 134.5-138.0° C.; ¹H NMR (300 MHz, CDCl₃) δ 3.81 (t, J=5.4 Hz, 2H), 3.62-3.56 (m, 2H), 3.43 (s, 6H), 2.76 (t, J=5.4 Hz, 2H), 2.29 (s, 6H), 1.71 (br s, 2H), 1.39-1.22 (m, 30H), 0.87 (t, J=6.3 Hz, 3H); low resolution mass spectrum (ESI) m/z 369.4 [M⁺; calcd for C₂₄H₅₃N₂: 369.42].

Compound (16,2,0) Bromide:

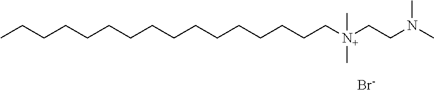 [SMILES: CCCCCCCCCCCCCCCC[N+](C)(C)CCN(C)C ; [Br-]]

To a solution of 1-bromohexadecane (1.448 g, 4.741 mmol) in acetone (2.4 mL) was added N,N,N′,N′-tetramethylethylenediamine (1.43 mL, 9.48 mmol). The resulting clear solution was warmed to reflux with stirring for 3 h. The reaction mixture was then concentrated in vacuo affording (16,2,0) (1.945 g, 97%) as a white solid: mp 81.0-88.5° C.; ¹H NMR (300 MHz, CDCl₃) δ 3.93 (t, J=5.7 Hz, 2H), 3.60-3.55 (m, 2H), 3.43 (s, 6H), 3.02 (t, J=5.1 Hz, 2H), 2.43 (s, 6H), 1.74 (br s, 2H), 1.40-1.15 (m, 26H), 0.87 (t, J=6.6 Hz, 3H); ¹³C NMR (75 MHz, CDCl₃) δ 64.83, 60.26, 53.99, 51.52, 45.42, 31.91, 29.68, 29.64, 29.59, 29.47, 29.41, 29.35, 29.24, 26.30, 22.91, 22.68, 14.13; low resolution mass spectrum (ESI) m/z 341.6 [M⁺; calcd for C₂₂H₄₉N₂: 341.39].

Compound (14,2,0) Bromide:

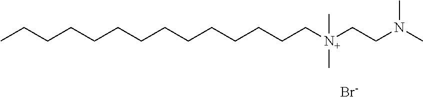 [SMILES: CCCCCCCCCCCCCC[N+](C)(C)CCN(C)C ; [Br-]]

To a solution of 1-bromotetradecane (1.38 mL, 5.07 mmol) in acetone (2.6 mL) was added N,N,N′,N′-tetramethylethylenediamine (1.53 mL, 10.1 mmol). The resulting clear solution was warmed to reflux with stirring for 3 h. The reaction mixture was then concentrated in vacuo affording (14,2,0) (1.983 g, 99%) as a white solid. ¹H NMR (300 MHz, CDCl₃) δ 3.78 (t, J=5.1 Hz, 2H), 3.59-3.54 (m, 2H), 3.41 (s, 6H), 2.75 (t, J=5.4 Hz, 2H), 2.28 (s, 6H), 1.40-1.20 (m, 22H), 0.87 (t, J=5.7 Hz, 3H); low resolution mass spectrum (ESI) m/z 313.4 [M⁺; calcd for C₂₀H₄₅N₂: 313.56].

Compound (12,2,0) Bromide:

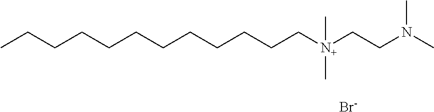 [SMILES: CCCCCCCCCCCC[N+](C)(C)CCN(C)C ; [Br-]]

To a solution of 1-bromododecane (1.363 g, 5.469 mmol) in acetone (2.8 mL) was added N,N,N′,N′-tetramethylethylenediamine (1.68 mL, 11.1 mmol). The resulting clear solution was warmed to reflux with stirring for 3 h. The reaction mixture was then concentrated in vacuo affording (12,2,0) (1.971 g, 99%) as a white solid: ¹H NMR (300 MHz, CDCl₃) δ 3.82 (t, J=5.7 Hz, 2H), 3.62-3.56 (m, 2H), 3.43 (s, 6H), 2.762 (t, J=6.0 Hz, 2H), 2.29 (s, 6H), 1.70 (br s, 2H), 1.39-1.28 (m, 18H), 0.87 (t, J=6.3 Hz, 3H); low resolution mass spectrum (ESI) m/z 285.3[M⁺; calcd for C₁₈H₄₁N₂: 285.34].

Compound (10,2,0) Bromide:

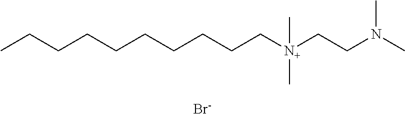 [SMILES: CCCCCCCCCC[N+](C)(C)CCN(C)C ; [Br-]]

To a solution of 1-bromodecane (1.20 g, 5.78 mmol) in acetone (3.0 mL) was added N,N,N′,N′-tetramethylethylenediamine (1.80 mL, 11.9 mmol). The resulting clear solution was warmed to reflux with stirring for 3 h. The reaction mixture was then concentrated in vacuo affording (10,2,0) (1.902 g, 98%) as a white solid: mp 72.5-79.0° C.; ¹H NMR (300 MHz, CDCl₃) δ 3.81 (t, J=5.7 Hz, 2H), 3.62-3.56 (m, 2H), 3.43 (s, 6H), 2.78-2.72 (m, 2H), 2.29 (s, 6H), 1.71 (br s, 2H), 1.40-1.23 (m, 14H), 0.88 (t, J=6.0 Hz, 3H); low resolution mass spectrum (ESI) m/z 257.3 [M⁺; calcd for C₁₆H₃₇N₂: 257.30].

Compound [8,2,0) Bromide:

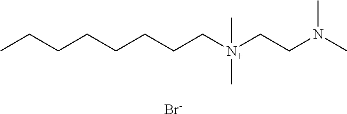 [SMILES: CCCCCCCC[N+](C)(C)CCN(C)C ; [Br-]]

To a solution of 1-bromooctane (2.734 g, 14.16 mmol) in acetone (6.6 mL) was added N,N,N′,N′-tetramethylethylenediamine (3.90 mL, 25.84 mmol). The resulting clear solution was warmed to reflux with stirring for 3 h. The reaction mixture was then concentrated in vacuo affording (8,2,0) (4.296 g, 98%) as a white solid: ¹H NMR (300 MHz, CDCl₃) δ 3.81 (t, J=5.1 Hz, 2H), 3.62-3.56 (m, 2H), 3.43 (s, 6H), 2.78-2.72 (m, 2H), 2.29 (s, 6H), 1.73 (br s, 2H), 1.40-1.23 (m, 10H), 0.88 (t, J=7.5 Hz, 3H); low resolution mass spectrum (ESI) m/z 229.3 [M⁺; calcd for C₁₄H₃₃N₂: 229.26].

For the compounds above, respective minimum inhibitory concentration (MIC) values against the Gram-positive S. aureus, E. faecalis, Gram-negative E. coli and P. aeruginosa were determined, respectively, by standard methods. The MIC was determined as the lowest final well concentration of compound to completely inhibit bacterial growth as detected by the unaided eye. Cell viability was verified by serial dilution and plating on MH agar. Both aqueous and fresh media positive controls were performed for each trial. Overnight bacterial cultures of Staphylococcus aureus (SH1000), Enterococcus faecalis (OG1RF), Escherichia coli (MC4100), and Pseudomonas aeruginosa (PAO1-WT) were grown in Mueller-Hinton broth at 37° C., with all but E. faecalis under shaking Overnight cultures were diluted to approximately 10⁶ cfu/mL as determined by OD measurement at 640 nm and plating on MH agar.

Each compound was serially diluted two-fold with water from 1 mM down to 1 μM yielding twelve dilutions per compound. In triplicate, 1004 of each dilution were pipetted into the appropriate well of a 96-well microtiter plate, and then 1004 of overnight bacterial culture diluted to ca. 10⁶ cfu/mL were inoculated into each well. Microtiter plates were incubated at 37° C. for 72 hours. Up to seven compounds were tested against one bacterial species at twelve decreasing concentrations per 96-well plate.

The MIC results are summarized in Table 1.

TABLE 1

| | Gram | Gram | Gram | |
|---|---|---|---|---|
| | positive | positive | negative | Gram negative |
| Compound | S. aureus | E. faecalis | E. coli | P. aeruginosa |
| (20, 2, 0) | 4 | 4 | 63 | 125 |
| (18, 2, 0) | 2 | 4 | 63 | 63 |
| (16, 2, 0) | 1 | 16 | 16 | 16 |
| (14, 2, 0) | 2 | 8 | 16 | 125 |
| (12, 2, 0) | 32 | 63 | 63 | 250 |
| (10, 2, 0) | 63 | 250 | 250 | 250 |
| (8, 2, 0) | >1000 | >1000 | >1000 | >1000 |
| (20, 2, 16) | 16 | 32 | 63 | 63 |
| (20, 2, 14) | 8 | 16 | 16 | 63 |
| (20, 2, 12) | 8 | 4 | 32 | 63 |
| (20, 2, 10) | 4 | 16 | 16 | 16 |
| (20, 2, 8) | 4 | 4 | 16 | 32 |
| (18, 2, 18) | 32 | 63 | 250 | 500 |
| (18, 2, 16) | 16 | 32 | 32 | 63 |
| (18, 2, 14) | 8 | 16 | 16 | 63 |
| (18, 2, 12) | 4 | 4 | 16 | 32 |
| (18, 2, 10) | 4 | 2 | 16 | 32 |
| (18, 2, 8) | 2 | 2 | 8 | 32 |
| (16, 2, 16) | 8 | 8 | 32 | 63 |
| (16, 2, 14) | 8 | 2 | 16 | 63 |
| (16, 2, 12) | 8 | 4 | 8 | 32 |
| (16, 2, 10) | 4 | 4 | 8 | 32 |
| (16, 2, 8) | 2 | 2 | 2 | 4 |
| (14, 2, 14) | 4 | 2 | 4 | 32 |
| (14, 2, 12) | 1 | 2 | 2 | 8 |
| (14, 2, 10) | 4 | 1 | 2 | 4 |
| (14, 2, 8) | 1 | 2 | 2 | 4 |
| (12, 2, 12) | 1 | 1 | 2 | 4 |
| (12, 2, 10) | 1 | 2 | 2 | 2 |
| (12, 2, 8) | 1 | 4 | 4 | 4 |
| (10, 2, 10) | 2 | 8 | 16 | 8 |
| (10, 2, 8) | 8 | 63 | 63 | 125 |
| (8, 2, 8) | 32 | 500 | 250 | 500 |
| (13, 2, 10) | 1 | 1 | 2 | 2 |
| (11, 2, 10) | 1 | 4 | 4 | 4 |
| benzalkonium chloride | 8 | 8 | 32 | 63 |

Examination of the antibacterial activity of the prepared amphiphiles reveals some trends. Monocationic compounds were generally less effective at inhibiting the Gram negative bacteria tested (E. coli and P. aeruginosa) as compared to the bis-alkylated counterparts. For example, (18,2,0) highlighted this trend, displaying MIC values of 2-4 μM versus Gram positive bacteria and 63 μM versus both Gram negative species.

Compounds with an aggregate of 20-24 side chain carbons displayed optimal activity. Some compounds displayed MIC values in single digits. Accordingly, asymmetric compounds (16,2,8) and (14,2,10), and symmetric comparative compound (12,2,12) are very active “24-carbon” compounds. Compounds (14,2,8) and (12,2,10) are two optimal “22-carbon” compounds. Compound (12,2,8) is a preferred compound with 20 carbons in the side chains. It was surprising to observe a relative uniformity of bioactivity, as many of these strongly inhibitory compounds showed nearly identical MIC values. A preferential activity of many compounds was shown against the Gram positive bacteria tested (S. aureus and E. faecalis). There was little differentiation in activity for the strongest compounds between Gram positive and Gram negative bacteria.

Two compounds with an odd number of side chain carbons were prepared: (13,2,10) and (11,2,10), which allowed for examination of compounds with 23 and 21 carbons in the side chains. Compounds (13,2,10) and (11,2,10) are two of the most potent compounds among the compounds tested. For example, compound (13,2,10) showed 1 μM inhibition of the Gram positive S. aureus and E. faecalis, as well as inhibition of E. coli and P. aeruginosa at 2 μM.

Asymmetric disposition of the side chain carbons led to modest changes in bioactivity, and good water solubility of relatively hydrophobic compounds. For example, the asymmetric (12,2,8) displayed lower MIC values than the symmetric (10,2,10) against all four bacteria tested. However, (16,2,8), (14,2,10), and (12,2,12) all showed comparable MIC values. More highly asymmetric compounds such as (20,2,8) and (18,2,8), while fully water soluble, showed diminished activity as compared to compounds with shorter aggregate side chains.

After accounting for costs of reagents, solvents, and percent yields, these potent biscationic amphiphiles can be prepared at relatively low cost. For example, compound (12,2,10), which showed MIC values of 2 μM or less against all four bacterial species tested, cost about $140 per mol to prepare; the preparation of the comparative compound having a gemini structure (12,2,12) totaled about $100/mol. While this may be more expensive than a fermented antiseptic such as ethanol, it is much cheaper than the preparations of benzalkonium chloride, which at about $85 per mol, shows 4-32 fold less activity. In addition, the method of making the asymmetric compound in the present disclosure provides operational simplicity. For example, all of our asymmetric TMEDA derivatives can be prepared as crystalline solids in about 24 hours in the laboratory.

Overall, the highly efficient preparation of a series of potent biscationic antimicrobials having the formula (I) or (II) has been developed. Many compounds prepared show low micromolar inhibition of bacterial growth. The lowest MIC values are observed for compounds with a total of 20-24 side chain carbons (i.e. m+n in the range from 20 to 24), particularly for the compounds with modest asymmetry.

2. Trisamine Bicationic or Tricationic Amphiphiles

Some embodiments provide an antimicrobial composition, comprising an effective amount of a compound having the formula:

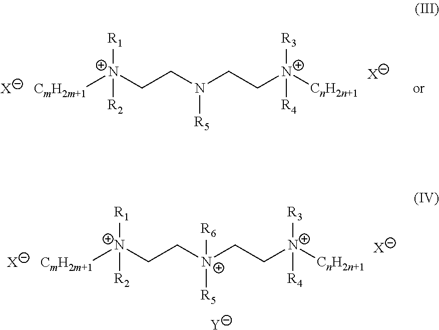

wherein:

R₁, R₂, R₃, R₄ R₅, or R₆ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

R′ is H or a C₁₋₄ alkyl,

X or Y is a halogen (in the form of anion), and

m and n are integers in the range from 5 to 25.

In some embodiments, R₁, R₂, R₃, R₄ R₅, or R₆ is H or a C₁₋₄ alkyl unsubstituted (e.g., methyl). X or Y is fluorine, chlorine, bromine, iodine, tosylate, citrate, any suitable anions or combinations thereof m can be equal to n, or m is not equal to n. m and n can be integers in the range from 10 to 14 in some embodiments.

In some embodiments, R₁, R₂, R₃, R₄ R₅, or R₆ is methyl, X is bromine, Y is iodine and the compound having formula (III) or (IV) is denoted as compound (m, 2, 0, 2, n) or (m, 2, 1, 2, n), respectively. Examples of the compound having formula (III) or (IV) include but are not limited to compound (10, 2, 0, 2, 10), compound (11, 2, 0, 2, 11), compound (12, 2, 0, 2, 12), compound (13, 2, 0, 2, 13), compound (14, 2, 0, 2, 14), compound (10, 2, 0, 2, 11), compound (10,2, 0, 2, 12), compound (10, 2, 0, 2, 13), compound (10, 2, 0, 2, 14), compound (11, 2, 0, 2, 12), compound (11, 2, 0, 2, 13), compound (11, 2, 0, 2, 14), compound (12, 2, 0, 2, 13), compound (12, 2, 0, 2, 14), compound (13, 2, 0, 2, 14), compound (10, 2, 1, 2, 10), compound (11, 2, 1, 2, 11), compound (12, 2, 1, 2, 12), compound (13, 2, 1, 2, 13), compound (14, 2, 1, 2, 14), compound (10, 2, 1, 2, 11), compound (10,2, 1, 2, 12), compound (10, 2, 1, 2, 13), compound (10, 2, 1, 2, 14), compound (11, 2, 1, 2, 12), compound (11, 2, 1, 2, 13), compound (11, 2, 1, 2, 14), compound (12, 2, 1, 2, 13), compound (12, 2, 1, 2, 14), compound (13, 2, 1, 2, 14), and combinations thereof.

The present disclosure also provide a method of making an antimicrobial composition, comprising mixing an effective amount of a compound having the formula (III) or (IV) and a carrier. Examples of a suitable carrier include but are not limited to a solvent. The antimicrobial composition can also comprise other ingredients and additives. The content of the compound having the formula (III) or (IV) in the antimicrobial composition can be in any suitable concentration. For example, in some embodiments, such a concentration can be in the range from 0.01 μM to 100 μM, for example, from 0.1 μM to 10 μM. In some embodiments, the content of the compound having the formula (III) or (IV) may be at a concentration of from 0.1 wt. % to 5 wt. %, for example, in the range of from 0.2 wt. % to 2.5 wt. %. Examples of the carrier include but are not limited to a solvent. Examples of other additives include but are not limited to surfactants, anti-foaming agents, anti-freezing agents, gelling agents, and combinations thereof. The antimicrobial composition may also comprise a pharmaceutically acceptable carrier or excipient. A pharmaceutically acceptable carrier or excipient suitable for a solid preparation such as tablets or capsules can be, for example, binders (e.g., acacia, gelatin, dextrin, hydroxypropylcellulose, methylcellulose, polyvinylpyrrolidone), solvents, dispersion media, diluents (e.g., lactose, sucrose, mannitol, corn starch, potato starch, calcium phosphate, calcium citrate, crystalline cellulose), lubricants (e.g., magnesium stearate, calcium stearate, stearic acid, talc, anhydrous silicic acid), disintegrants (e.g., corn starch, potato starch, carboxymethylcellulose, carboxymethylcellulose calcium, alginic acid), and wetting agents (e.g., sodium laurylsulfate). A pharmaceutically acceptable carrier or excipient suitable for a liquid preparation, such as solutions or suspensions, can be, for example, aqueous vehicles (e.g., water), suspending agents (e.g., acacia, gelatin, methyl cellulose, carboxymethylcellulose sodium, hydroxymethyl-cellulose, aluminum stearate gel), surfactants (e.g., lecithin, sorbitan monooleate, glycerin monostearate), and non-aqueous vehicles (e.g., glycerin, propylene glycol, vegetable oil). Moreover, liquid preparations may contain preservatives (e.g., p-hydroxybenzoic acid methyl ester, p-hydroxybenzoic acid propyl ester), flavors, and/or coloring agents. The antimicrobial composition in this disclosure can be formulated to be in any suitable form, including but not limited to liquid, gel and paste.

The present disclosure also provide a method of using the composition comprising a compound having the formula (III) or (IV) as described for antimicrobial use. The compound or the composition is used to kill or inhibit growth of at least one group of microorganisms selected from the group consisting of bacteria, viruses, yeast, fungi, and protozoa. The method can be also used to kill or disperse pre-established bacterial biofilms (i.e. antibiofilm use). The method may comprise forming a film or coating comprising the antimicrobial composition comprising a compound having formula (III) or (IV), which can be grafted onto a solid surface.

In another aspect, the present disclosure provides a film or coating comprising a compound having formula (III) or (IV) grafted onto a solid surface having a structure:

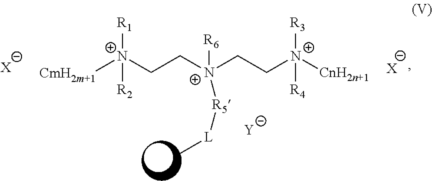

wherein:

R₁, R₂, R₃, R₄, or R₆ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

R₅^{′} is a chemical alkylene moiety unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,

R′ is H or a C₁₋₄ alkyl,

X or Y is a halogen (in the form of anion),

m and n are integers in the range from 5 to 25, and

L is a linker comprising a functional group.

In some embodiments, R₁, R₂, R₃, R₄ or R₆ is H or a C₁₋₄ alkyl unsubstituted such as methyl, R₅′ is a C₁₋₄ alkylene, and X or Y is fluorine, chlorine, bromine, iodine, tosylate, citrate, any suitable anions or combinations thereof m can be equal to or different from n. Each of m and n can be an integer in the range from 10 to 14. For example, R₁, R₂, R₃, R₄ or R₆ is methyl, R₅′ is methylene, X is bromine, and Y is iodine. L may comprise any suitable linker group, for example, at least one of —NH—CO—, —C(O)— and an alkylene group. The film or coating is configured to kill or inhibit growth of at least one group of microorganisms selected from the group consisting of bacteria, viruses, yeast, fungi, and protozoa. The film or coating can be obtained by grafting a compound having the formula (III) or (IV) onto the surface of a solid substrate. Examples of a solid substrate include but are not limited to a metal, a polymer and a glass substrate. The thickness of the film or coating can be in any suitable thickness, ranging from a monolayer to a level of microns.

### Examples

### 1. Preparation of Trisamine Compounds

Compound (m,2,0,2,n) can be prepared using the following reaction in Scheme 6. Synthesis of compound (12,2,0,2,12) is shown as an exemplary preparation in Scheme 6.

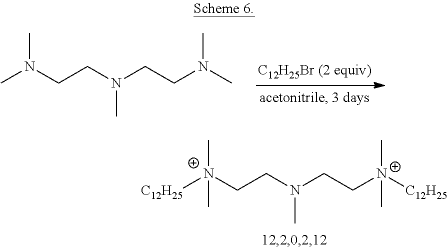

Synthesis of an exemplary compound (14,2,0,2,14) is described below as representative procedure of preparing compound (m, 2,0, 2,n).

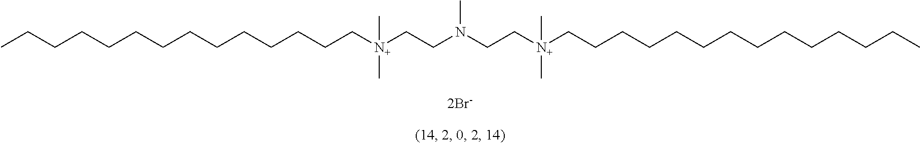 [SMILES: CCCCCCCCCCCCCC[N+](C)(C)CCN(C)CC[N+](C)(C)CCCCCCCCCCCCCC]

To a solution of 1-bromotetradecane (2.25 mL, 8.26 mmol) in CH₃CN (2 mL) was added N,N,N′,N″,N″-pentamethyldiethylenetriamine (0.87 mL, 4.2 mmol). The resulting clear solution was stirred at rt for 20 h, during which time a white solid was observed. To the reaction mixture was added cold acetone (˜9 mL), which led to a white precipitate. Filtration through a Buchner funnel furnished a white solid, which was washed with cold acetone (˜4 mL) and then hexanes (˜4 mL), affording (14,2,0,2,14) (2.188 g, 73%) as a white solid.

### 2. Preparation of Trisammonium Compounds

Compound (m,2,1,2,n) can be prepared using the following reaction in Scheme 7. Synthesis of compound (12,2,1,2,12) is shown as an exemplary preparation in Scheme 7.

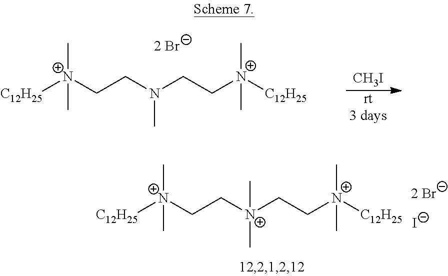

Synthesis of an exemplary compound (12,2,1,2,12) is described below as representative procedure of preparing compound (m, 2,1, 2, n).

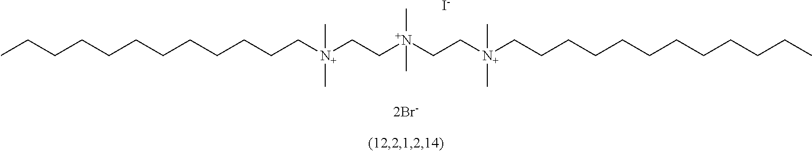 [SMILES: [I-] ; CCCCCCCCCCCC[N+](C)(C)CC[N+](C)(C)CC[N+](C)(C)CCCCCCCCCCCC]

To a solution of CH₃I (˜1.0 mL, 16 mmol) was added (12,2,0,2,12) (201 mg, 0.299 mmol). The resulting clear yellow solution was stirred at room, and additional CH₃I was added over 72 hours, during which time a solid was observed. Crude ¹H NMR showed that (12,2,1,2,12) was the major product.

### 3. Biological Activity of Trisamine Compounds, μM

Compound (12,2,0,2,12) causes a visual disruption of pre-established Staph aureus biofilms at 25 μM (micromolar). Thus it at least disperses biofilms at 25 μM.

The MIC values of compounds (10,2,0,2,10), (12,2,0,2,12), and (14,2,0,2,14) against four different bacteria are shown in Table 2. The data are also compared to norspermidine derivatives for antimicrobial ability as shown in Table 3 and Table 4. See Bottcher, T.; Kolodkin-Gal, I.; Kolter, R.; Losick, R.; Clardy, J. J. Am. Chem. Soc. 2013, 135, 2927. Compound (12,2,0,2,12) shows a MIC of 4 μM or less against the same four bacteria than that of the norspermidine derivatives described by Bottcher, et al. For example, the best compound reported by by Bottcher, et al. inhibited biofilm formation at 20 uM in S. aureus, which is 10 times worse than the compounds provided in the present disclosure.

TABLE 2
(MIC values in μM).

| Compound | S. aureus | E. coli | E faecalis | P aeruginosa |
|---|---|---|---|---|
| 10, 2, 0, 2, 10 | 2 | 8 | 8 | 32 |
| 12, 2, 0, 2, 12 | 1 | 1 | 2 | 4 |
| 14, 2, 0, 2, 14 | 2 | 4 | 2 | 32 |

TABLE 3

| | 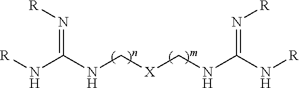 | | | | |
|---|---|---|---|---|---|
| No. | n | m | X | R | form |
| 1 | 2 | 0 | — | H | SO₄²⁻ |
| 2 | 2 | 2 | NH | H | 2a SO₄²⁻ |
| | | | | | 2b base |
| 3 | 2 | 2 | N—C(═NR)NHR | iPr | Cl⁻ |
| 4 | 3 | 0 | — | H | SO₄²⁻ |
| 5 | 3 | 3 | NH | H | 5a SO₄²⁻ |
| | | | | | 5b base |
| 6 | 3 | 3 | N—C(═NH)NH₂ | H | 6a Cl⁻ |
| | | | | | 6b base |
| 7 | 3 | 3 | 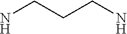 | H | 7a SO₄²⁻ 7b base |
| 8 | 3 | 4 | NH | H | 8a SO₄²⁻ 8b base |
| | 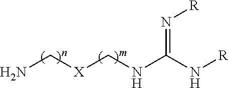 | | | | |
| No. | n | m | X | R | form |
| 9 | 3 | 0 | — | H | SO₄²⁻ |
| 10 | 3 | 3 | NH | iPr | HCOO⁻ |

| | | |
|---|---|---|
| 11 | 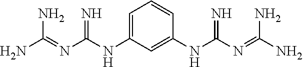 [SMILES: N=C(N=C(N)N)Nc1cccc(NC(=N)N=C(N)N)c1] | 11a Cl⁻ 11b base |
| 12 | 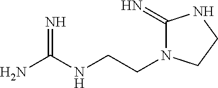 [SMILES: N=C(N)NCCN1CCNC1=N] | SO₄²⁻ |

TABLE 4
Table 1. Activities of Selected Compounds

MBIC (μM) at pH 7.4

| compound | B. subtilis | S. aureus |
|---|---|---|
| 4 | >1000 | 50 |
| 5a | 500 | 75 |
| 5b | 375 ± 126 | 400 |
| 6a | 10^{a} | >1000 (500″) |
| 6b | 10 | 50 |
| 7a | 3 | 56 ± 15 |
| 7b | 2 | 250 |
| 9 | 100 | 500 |
| 10 | 30 | 20 ± 10 |
| 11a | 30 | 300 |
| 11b | 7 ± 3 | 750 ± 250 |

^{a}Incomplete inhibition.

### 4. Surface Attachment for Film or Coating

A film or coating can be prepared by grafting a compound having formula (III) or (IV) onto a solid surface having a structure (V). The following scheme (scheme 8) illustrates three exemplary preparation methods.

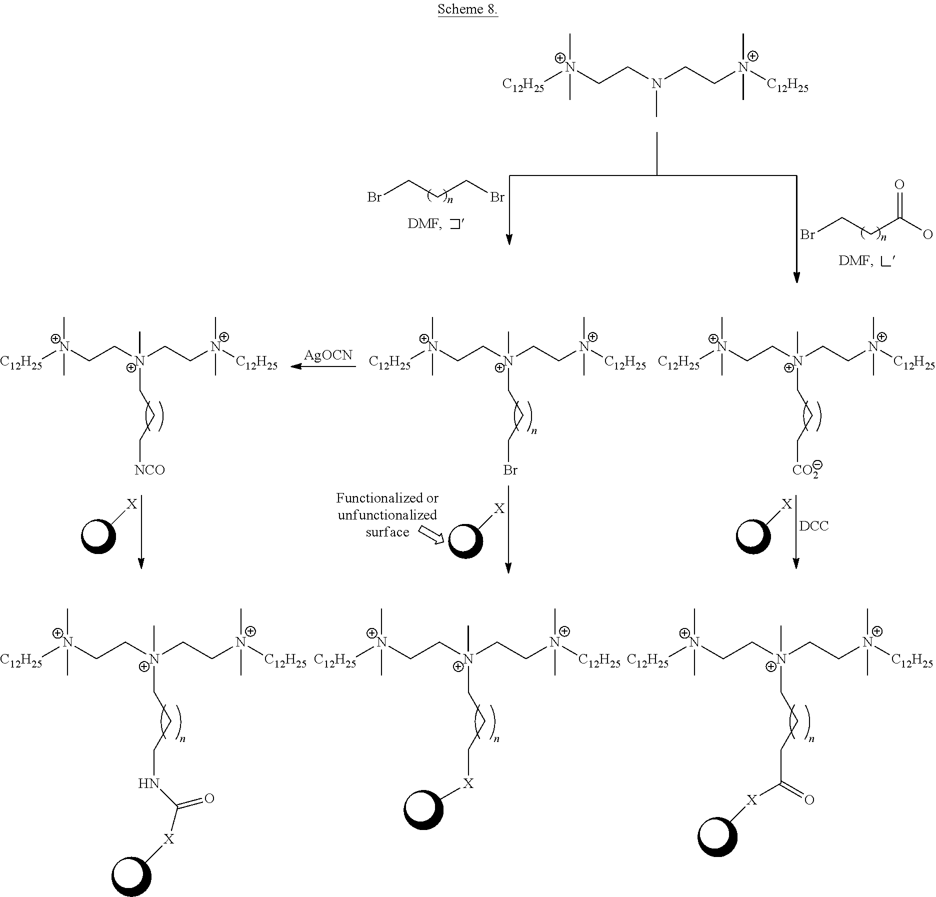

The resulting film or coating provided in the disclosure has an ability to kill or inhibit the growth of microorganisms, including but are not limited to bacteria, viruses, yeast, fungi, and protozoa. The film or coating can be also used to kill or disperse pre-established bacterial biofilms (i.e. antibiofilm use).

Although the subject matter has been described in terms of exemplary embodiments, it is not limited thereto. Rather, the appended claims should be construed broadly, to include other variants and embodiments, which may be made by those skilled in the art.

What is claimed is:

1. A method of killing or inhibiting microbial growth, comprising applying an antimicrobial composition comprising a compound having the formula 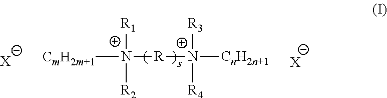
wherein:
R is a methylene group unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
s is an integer in the range from 1 to 6,
R₁, R₂, R₃ or R₄ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
R′ is H or a C₁₋₄ alkyl,
X is a halogen,
m and n are integers in the range from 5 to 25, and
m is not equal to n.

2. The method of claim 1, wherein
R is a methylene group,
s is an integer in the range from 2 to 5,
R₁, R₂, R₃ or R₄ is a C₁₋₄ alkyl, and
X is chlorine or bromine.

3. The method of claim 1, wherein the antimicrobial composition comprises a compound having the formula 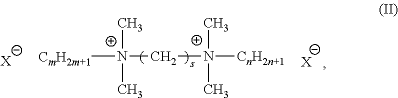
denoted as compound (m, s, n) halide,
wherein
s is an integer in the range from 1 to 6,
X is a halogen,
m and n are integers in the range from 5 to 25, and m is not equal to n.

4. The method of claim 3, wherein
s is an integer in the range from 2 to 5, and
X is chlorine or bromine.

5. The method of claim 3, wherein
m+n is in the range of from 18 to 36, and the difference between m and n is in the range from 1 to 10.

6. The method of claim 3, wherein the compound having the formula (II) denoted as a compound (m, s, n) halide is a bromide and is selected from a group consisting of:
compound (20, 2, 16), compound (20, 2, 14), compound (20, 2, 14), compound (20, 2, 10), compound (20, 2, 8), compound (20, 2, 6), compound (18, 2, 16), compound (18, 2, 14), compound (18, 2, 12), compound (18, 2, 10), compound (16, 2, 8), compound (14, 2, 12), compound (14, 2, 10), compound (14, 2, 8), compound (12, 2, 10), compound (12, 2, 8), compound (13, 2, 10), compound (13, 2, 10) and compound (10, 2, 8).

7. The method of claim 3, wherein
m+n is in the range of from 20 to 24, and the difference between m and n is in the range from 1 to 8.

8. The method of claim 3, wherein the compound having the formula (II) denoted as compound (m, s, n) halide is a bromide and is selected from a group consisting of:
compound (16, 2, 8), compound (14, 2, 10), compound (14, 2, 8), compound (12, 2, 10), compound (12, 2, 8), compound (13, 2, 10) and compound (11, 2, 10).

9. The method of claim 1, wherein the antimicrobial composition is used to kill or inhibit growth of at least one group of microorganisms selected from the group consisting of bacteria, viruses, yeast, fungi, and protozoa, or to kill or disperse a pre-established biofilm.

10. An antimicrobial composition comprising a compound having the formula 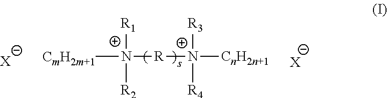
and a carrier,
wherein:
R is a methylene group unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
s is an integer in the range from 1 to 6,
R₁, R₂, R₃ or R₄ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
R′ is H or a C₁₋₄ alkyl,
X is a halogen,
m and n are integers in the range from 5 to 25, and
m is not equal to n.

11. The antimicrobial composition of claim 10, wherein
R is a methylene group,
s is an integer in the range from 2 to 5,
R₁, R₂, R₃ or R₄ is a C₁₋₄ alkyl, and
X is chlorine or bromine.

12. The antimicrobial composition of claim 10, wherein the compound having the formula (I) is a compound having the formula 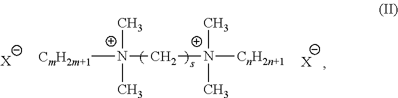
denoted as compound (m, s, n) halide,
wherein
s is an integer in the range from 1 to 6,
X is a halogen,
m and n are integers in the range from 5 to 25, and m is not equal to n.

13. The antimicrobial composition of claim 12, wherein
s is an integer in the range from 2 to 5, and
X is chlorine or bromine.

14. The antimicrobial composition of claim 12, wherein
m+n is in the range of from 18 to 36, and the difference between m and n is in the range from 1 to 10.

15. The antimicrobial composition of claim 12, wherein the compound having the formula (II) denoted as a compound (m, s, n) halide is a bromide and is selected from a group consisting of:
compound (20, 2, 16), compound (20, 2, 14), compound (20, 2, 14), compound (20, 2, 10), compound (20, 2, 8), compound (20, 2, 6), compound (18, 2, 16), compound (18, 2, 14), compound (18, 2, 12), compound (18, 2, 10), compound (16, 2, 8), compound (14, 2, 12), compound (14, 2, 10), compound (14, 2, 8), compound (12, 2, 10), compound (12, 2, 8), compound (13, 2, 10), compound (13, 2, 10) and compound (10, 2, 8).

16. The antimicrobial composition of claim 12, wherein
m+n is in the range of from 20 to 24, and the difference between m and n is in the range from 1 to 8.

17. The antimicrobial composition of claim 12, wherein the compound having the formula (II) denoted as compound (m, s, n) halide is a bromide and is selected from a group consisting of:
compound (16, 2, 8), compound (14, 2, 10), compound (14, 2, 8), compound (12, 2, 10), compound (12, 2, 8), compound (13, 2, 10) and compound (11, 2, 10).

18. A method of making an antimicrobial composition comprising mixing a compound having the formula 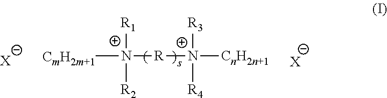
and a carrier,
wherein:
R is a methylene group unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
s is an integer in the range from 1 to 6,
R₁, R₂, R₃ or R₄ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
R′ is H or a C₁₋₄ alkyl,
X is a halogen,
m and n are integers in the range from 5 to 25, and
m is not equal to n.

19. The method of claim 18, wherein
R is a methylene group,
s is an integer in the range from 2 to 5,
R₁, R₂, R₃ or R₄ is a C₁₋₄ alkyl, and
X is chlorine or bromine.

20. The method of claim 18, wherein the compound having the formula (I) is a compound having the formula 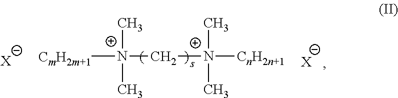
denoted as compound (m, s, n) halide,
wherein
s is an integer in the range from 1 to 6,
X is a halogen,
m and n are integers in the range from 5 to 25, and m is not equal to n.

21. The method of claim 20, wherein
s is an integer in the range from 2 to 5, and
X is chlorine or bromine.

22. The method of claim 20, wherein
m+n is in the range of from 20 to 24, and the difference between m and n is in the range from 1 to 8.

23. The method of claim 20, wherein the compound having the formula (II) denoted as compound (m, s, n) halide is a bromide and is selected from a group consisting of:
compound (16, 2, 8), compound (14, 2, 10), compound (14, 2, 8), compound (12, 2, 10), compound (12, 2, 8), compound (13, 2, 10) and compound (11, 2, 10).

24. An antimicrobial composition, comprising an effective amount of a compound having the formula: 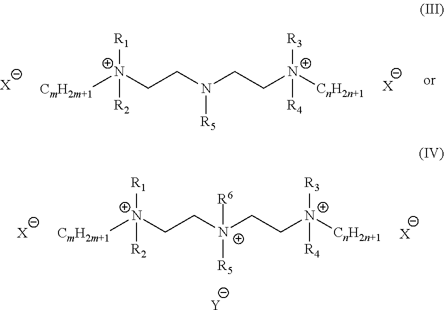
wherein:
R₁, R₂, R₃, R₄ R₅, or R₆ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
R′ is H or a C₁₋₄ alkyl,
X or Y is a halogen, and
m and n are integers in the range from 5 to 25.

25. The antimicrobial composition of claim 24, wherein
R₁, R₂, R₃, R₄ R₅, or R₆ is H or a C₁₋₄ alkyl unsubstituted, and
X or Y is chlorine, bromine or iodine.

26. The antimicrobial composition of claim 24, wherein m is equal to n.

27. The antimicrobial composition of claim 24, wherein m is not equal to n.

28. The antimicrobial composition of claim 24, wherein m and n are integers in the range from 10 to 14.

29. The antimicrobial composition of claim 24, wherein
R₁, R₂, R₃, R₄ R₅, or R₆ is methyl, X is bromine, Y is iodine and the compound having formula (III) or (IV) is denoted as compound (m, 2, 0, 2, n) or (m, 2, 1, 2, n), respectively.

30. The antimicrobial composition of claim 29, wherein the compound having formula (III) or (IV) is selected from a group consisting of:
compound (10, 2, 0, 2, 10), compound (11, 2, 0, 2, 11), compound (12, 2, 0, 2, 12), compound (13, 2, 0, 2, 13), compound (14, 2, 0, 2, 14), compound (10, 2, 0, 2, 11), compound (10,2, 0, 2, 12), compound (10, 2, 0, 2, 13), compound (10, 2, 0, 2, 14), compound (11, 2, 0, 2, 12), compound (11, 2, 0, 2, 13), compound (11, 2, 0, 2, 14), compound (12, 2, 0, 2, 13), compound (12, 2, 0, 2, 14), compound (13, 2, 0, 2, 14),
compound (10, 2, 1, 2, 10), compound (11, 2, 1, 2, 11), compound (12, 2, 1, 2, 12), compound (13, 2, 1, 2, 13), compound (14, 2, 1, 2, 14), compound (10, 2, 1, 2, 11), compound (10,2, 1, 2, 12), compound (10, 2, 1, 2, 13), compound (10, 2, 1, 2, 14), compound (11, 2, 1, 2, 12), compound (11, 2, 1, 2, 13), compound (11, 2, 1, 2, 14), compound (12, 2, 1, 2, 13), compound (12, 2, 1, 2, 14) and compound (13, 2, 1, 2, 14).

31. A method of making an antimicrobial composition, comprising mixing an effective amount of a compound having the formula: 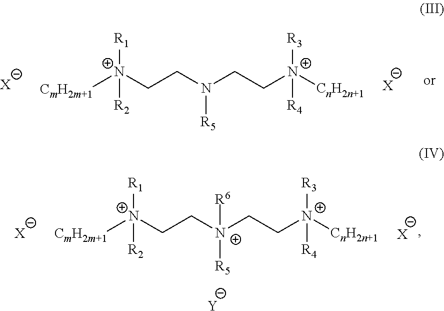
with a carrier,
wherein:
R₁, R₂, R₃, R₄ R₅, or R₆ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
R′ is H or a C₁₋₄ alkyl,
X or Y is a halogen, and
m and n are integers in the range from 5 to 25.

32. The method of claim 31, wherein
R₁, R₂, R₃, R₄ R₅, or R₆ is H or a C₁₋₄ alkyl unsubstituted, and
X or Y is chlorine, bromine or iodine.

33. The method of claim 31, wherein m is equal to n.

34. The method of claim 31, wherein m is not equal to n.

35. The method of claim 31, wherein m and n are integers in the range from 10 to 14.

36. The method of claim 31, wherein
R₁, R₂, R₃, R₄ R₅, or R₆ is methyl, X is bromine, Y is iodine and the compound having formula (III) or (IV) is denoted as compound (m, 2, 0, 2, n) or (m, 2, 1, 2, n), respectively.

37. The method of claim 31, wherein the compound having formula (III) or (IV) is selected from a group consisting of:
compound (10, 2, 0, 2, 10), compound (11, 2, 0, 2, 11), compound (12, 2, 0, 2, 12), compound (13, 2, 0, 2, 13), compound (14, 2, 0, 2, 14), compound (10, 2, 0, 2, 11), compound (10,2, 0, 2, 12), compound (10, 2, 0, 2, 13), compound (10, 2, 0, 2, 14), compound (11, 2, 0, 2, 12), compound (11, 2, 0, 2, 13), compound (11, 2, 0, 2, 14), compound (12, 2, 0, 2, 13), compound (12, 2, 0, 2, 14), compound (13, 2, 0, 2, 14),
compound (10, 2, 1, 2, 10), compound (11, 2, 1, 2, 11), compound (12, 2, 1, 2, 12), compound (13, 2, 1, 2, 13), compound (14, 2, 1, 2, 14), compound (10, 2, 1, 2, 11), compound (10,2, 1, 2, 12), compound (10, 2, 1, 2, 13), compound (10, 2, 1, 2, 14), compound (11, 2, 1, 2, 12), compound (11, 2, 1, 2, 13), compound (11, 2, 1, 2, 14), compound (12, 2, 1, 2, 13), compound (12, 2, 1, 2, 14) and compound (13, 2, 1, 2, 14).

38. A method of killing or inhibiting microbial growth, comprising applying an antimicrobial composition comprising a compound having the formula 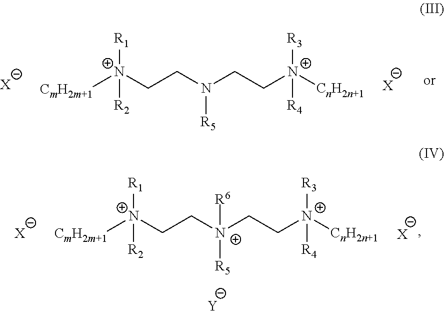
with a carrier
wherein:
R₁, R₂, R₃, R₄ R₅, or R₆ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
R′ is H or a C₁₋₄ alkyl,
X or Y is a halogen, and
m and n are integers in the range from 5 to 25.

39. The method of claim 38, wherein the antimicrobial composition is used to kill or inhibit growth of at least one group of microorganisms selected from the group consisting of bacteria, viruses, yeast, fungi, and protozoa, or to kill or disperse a pre-established biofilm.

40. The method of claim 38, comprising forming a film or coating comprising the antimicrobial composition comprising a compound having formula (III) or (IV).

41. A film or coating comprising a compound grafted onto a solid surface having a structure: 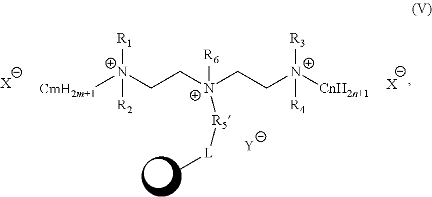
wherein:
R₁, R₂, R₃, R₄, or R₆ is H or a C₁₋₄ alkyl unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
R₅^{′} is a chemical alkylene moiety unsubstituted or optionally substituted with a functional group selected from the group consisting of —OH, —OR′, —NH₂, —NHR′, —NR′₂, —SH, —SR′, —O—C(O)R′, —C(O)R′, —CF₃, and —OCF₃,
R′ is H or a C₁₋₄ alkyl,
X or Y is a halogen,
m and n are integers in the range from 5 to 25, and
L is a linker comprising a functional group.

42. The film or coating of claim 41, wherein
R₁, R₂, R₃, R₄ or R₆ is H or a C₁₋₄ alkyl unsubstituted,
R₅′ is a C₁₋₄ alkylene, and
X or Y is chlorine, bromine or iodine.

43. The film or coating of claim 41, wherein m is equal to n.

44. The film or coating of claim 41, wherein m is not equal to n.

45. The film or coating of claim 41, wherein m and n are integers in the range from 10 to 14.

46. The film or coating of claim 41, wherein
R₁, R₂, R₃, R₄ or R₆ is methyl, R₅′ is methylene, X is bromine, and Y is iodine.

47. The film or coating of claim 41, wherein L comprising at least one of —NH—CO—, —C(O)— and an alkylene group.

48. The film or coating of claim 41, wherein the film or coating is configured to kill or inhibit growth of at least one group of microorganisms selected from the group consisting of bacteria, viruses, yeast, fungi, and protozoa, or to kill or disperse a pre-established biofilm.
